(19) United States
(12) Patent Application Publication
(10) Pub. No.: US 2026/0288737 A1
(43) Pub. Date: Sep. 24, 2026

(54) SYSTEM

(71) Applicant: SoftBank Group Corp., Tokyo (JP)

(72) Inventor: Yushi KITAZAWA, Tokyo (JP)

(73) Assignee: SoftBank Group Corp., Tokyo (JP)

(21) Appl. No.: 19/567,383

(22) Filed: Mar. 16, 2026

(30) Foreign Application Priority Data
Mar. 19, 2025 (JP) 2025-045118

(51) Int. Cl. G06F 16/2457; G06F 16/242; G06F 16/28; G06F 40/103; G06F 40/284; G06F 40/295; G06F 40/40; G10L 15/26; G10L 25/63

(52) U.S. Cl. CPC G06F 16/24578; G06F 16/243; G06F 16/285; G06F 40/103; G06F 40/295; G06F 40/40; G06F 40/284; G10L 15/26; G10L 25/63

(57) ABSTRACT

A system including a processor, wherein the processor is configured to receive, as source data, meeting audio data, messages of a communication means, and non-confidential documents, analyze the received source data by using natural language processing techniques to understand business contents of each organization, and generate, based on the understood business contents, a prompt for instructing a generative AI model to verbalize solutions and issues.

### CROSS-REFERENCE TO RELATED APPLICATION

This application is based on and claims priority under 35 USC 119 from Japanese Patent Application No. 2025-045118 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional organizational information systems are unable to effectively utilize heterogeneous internal data such as meeting audio, communication messages, and non-confidential documents to systematically understand business contents of each organization and to generate clear descriptions of solutions and issues. In many cases, meeting audio data remains untranscribed or is only archived without structured analysis, communication messages in tools such as chat applications are fragmented and difficult to integrate, and non-confidential internal documents are not dynamically analyzed in relation to ongoing activities and problems. As a result, organizations face difficulties in promptly identifying issues across departments, in formulating appropriate solutions, and in sharing such knowledge in a form that is easy to understand and reuse. Furthermore, existing systems that apply natural language processing often stop at simple keyword extraction or topic classification and do not provide a mechanism to generate high-quality natural language expressions of solutions and issues tailored to the organization. There is therefore a need for a system that can comprehensively receive various types of internal source data, analyze them to understand business contents, and automatically generate prompts for a generative AI model so that the generative AI model can verbalize solutions and issues in a consistent and useful manner.

### SUMMARY

In order to solve the above-described problems, a system according to one aspect of the present invention comprises a processor configured to receive, as source data, meeting audio data, messages of a communication means, and non-confidential documents, analyze the received source data by using natural language processing techniques to understand business contents of each organization, and generate, based on the understood business contents, a prompt for instructing a generative AI model to verbalize solutions and issues. The processor is further configured, in one embodiment, to input the generated prompt into the generative AI model and receive a response from the generative AI model. In another embodiment, the processor is configured to provide a result returned from the generative AI model through a display device or an audio output device. By generating prompts that are adapted to the organization-specific business contents and by using a generative AI model to produce natural language descriptions of solutions and issues, the system enables automatic extraction, verbalization, and presentation of organizational problems and corresponding solutions from diverse internal data sources.

The term “system” refers to a combination of hardware and software components including at least one processor configured to execute the functions recited in the claims. The term “processor” refers to any hardware element, such as a central processing unit (CPU), graphics processing unit (GPU), microcontroller, or specialized processing circuitry, or any combination thereof, that is capable of executing instructions to perform the claimed operations.

The term “source data” refers to input data including meeting audio data, messages of a communication means, and non-confidential documents that are used by the processor as the basis for analysis.

The term “meeting audio data” refers to audio recordings of meetings, conferences, discussions, or similar gatherings in which participants communicate by voice.

The term “messages of a communication means” refers to textual or textualized communications exchanged through electronic communication tools, including but not limited to chat systems, messaging applications, email systems, and collaboration platforms.

The term “non-confidential documents” refers to documents stored within an organization that are not classified as confidential or secret according to the organization's policies and that are permitted to be processed by the system.

The term “natural language processing techniques” refers to computational methods and algorithms for analyzing and processing human language in textual form, including but not limited to tokenization, part-of-speech tagging, syntactic parsing, semantic analysis, entity recognition, topic extraction, and text classification.

The term “business contents of each organization” refers to information describing activities, operations, processes, issues, decisions, and related contextual data of a particular organization or organizational unit derived from the source data.

The term “prompt” refers to a text or structured input generated by the processor and provided to a generative AI model in order to instruct the generative AI model to perform a specific task, such as verbalizing solutions and issues.

The term “generative AI model” refers to a machine learning model trained to generate natural language text or other content based on input prompts, including but not limited to large language models and similar generative models.

The term “verbalize solutions and issues” refers to generating natural language expressions that describe, in a human-readable form, one or more solutions to identified problems and one or more issues or problems themselves, based on the business contents understood from the source data.

The term “response from the generative AI model” refers to output data, typically in the form of natural language text, that is generated by the generative AI model in reply to a given prompt.

The term “display device” refers to any hardware device capable of visually presenting information to a user, including but not limited to computer monitors, tablet displays, smartphone screens, and large-format displays.

The term “audio output device” refers to any hardware device capable of generating audible sound for a user, including but not limited to speakers, headphones, and earphones.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments, A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

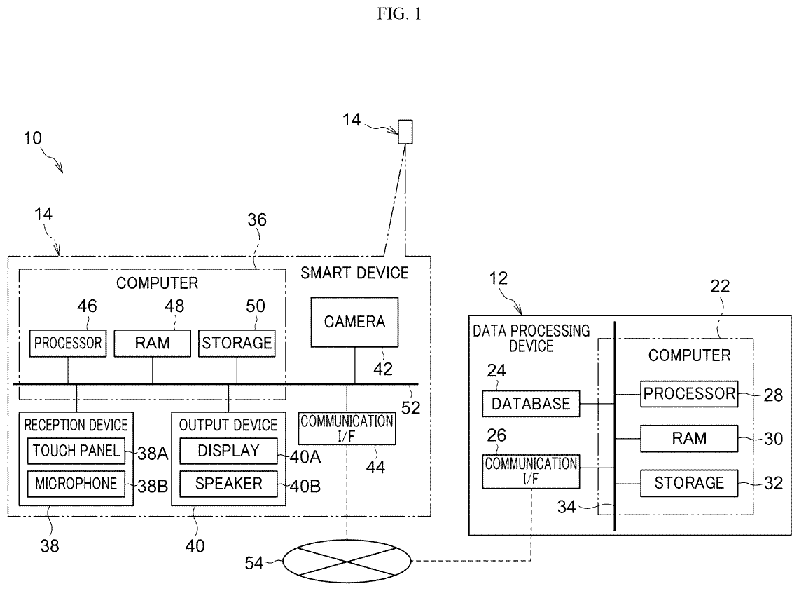

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

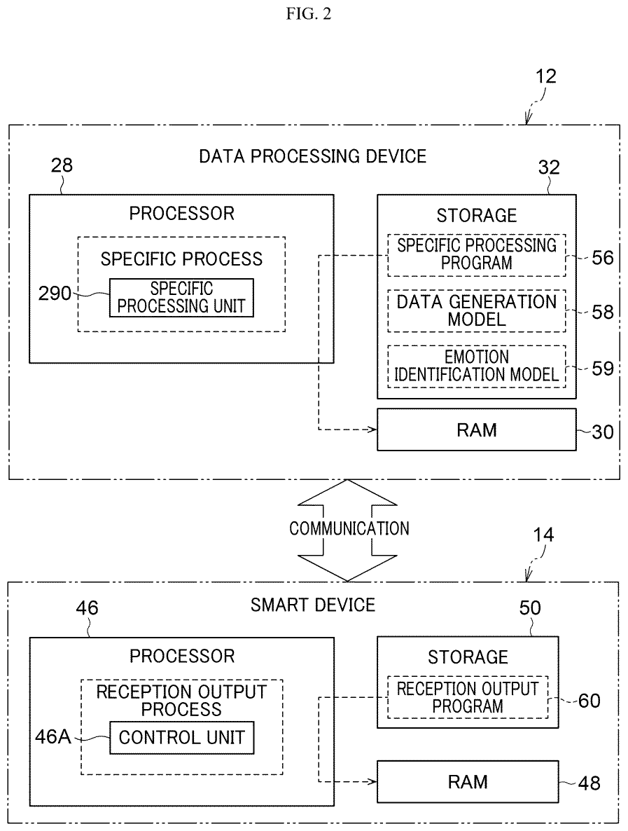

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In modern organizations, large volumes of heterogeneous digital information, such as meeting audio recordings, electronic messages exchanged via communication tools, and internal reference materials, are continuously generated and stored in distributed information processing environments. Conventional systems typically treat these datasets as isolated content streams and rely on manual review or simple keyword search to identify business issues, candidate solutions, and organization-wide trends. As a result, users are required to navigate multiple applications, repeatedly refine search conditions, and manually correlate unstructured text segments to derive actionable insight, which leads to significant latency, cognitive load, and inconsistency in decision making.

From a computer technology perspective, conventional information processing systems lack an integrated processing pipeline that (i) automatically transforms heterogeneous, multi-modal source information into machine-interpretable structured data, (ii) tightly couples this structured data with a generative artificial intelligence model through dynamically constructed, context-rich prompt sentences, and (iii) closes the loop between natural-language user queries and underlying data structures so that the system can efficiently retrieve, condition, and present only data that is relevant to the user's intent. Existing systems either invoke a generative artificial intelligence model directly on raw text without structured aggregation, which results in non-deterministic and data-inefficient responses, or perform analytics in a separate reporting tier without exploiting generative models to synthesize and adapt the output to user-specific natural-language requests.

Furthermore, conventional dashboards and visualization tools are generally configured manually and are not semantically linked to the natural-language answers produced by generative models. Consequently, the computing environment cannot provide end-to-end traceability from each generated sentence back to the underlying structured records and indicators, and cannot automatically surface appropriate visualization screens in response to user interactions with generated text. This disconnect causes redundant data transfers, inefficient query patterns, and fragmented user interfaces, which in turn degrade system-level performance and usability.

Accordingly, there is a need for an improved computer-implemented system that integrates speech recognition, natural language processing, structured data generation, full-text indexing, and generative artificial intelligence models under unified prompt management and context construction. Such a system should automatically derive business content, issues, and candidate solutions from heterogeneous organizational information, should generate and refine prompt sentences using structured context tailored to both system-driven analysis and user-driven natural-language queries, and should associate generative outputs with visualization data and interaction flows. By doing so, the system can improve the technical functioning of the underlying information processing platform, reduce computational redundancy in querying and summarization, and provide more efficient access paths from user input to relevant, data-grounded outputs.

The specific processing by the specific processing unit 290 of the data processing device 12 in Example 1 is realized by the following means.

The present invention provides a server comprising a processor configured to acquire heterogeneous source information including meeting audio information, text information obtained via a communication means, and non-confidential reference information, and to store the acquired source information in at least one storage device; to convert the meeting audio information into character information by using a speech recognition technique, to extract text information from the text information obtained via the communication means and from the non-confidential reference information, and to perform preprocessing on the character information and the text information by using a natural language processing technique including sentence segmentation, word segmentation, part-of-speech tagging, and syntactic analysis, thereby extracting descriptions indicating business content, issues, and candidate solutions and storing an extraction result as structured data in a data store; to classify the business content, the issues, and the candidate solutions on the basis of the structured data, to aggregate the business content, the issues, and the candidate solutions according to frequency information, time-series information, and affiliation information, and to generate summary information for each organization unit or each period; to automatically generate a prompt sentence that instructs a generative artificial intelligence model to generate a natural-language response relating to the business content, the issues, and the candidate solutions, on the basis of the summary information and the structured data, and to construct the prompt sentence so as to include query conditions and an output format; to input the prompt sentence to the generative artificial intelligence model via a communication interface, to receive a response result returned from the generative artificial intelligence model, and to store the response result in association with the structured data; to calculate indicators indicating occurrence tendencies of the issues, proposal states of the candidate solutions, and business states for each organization on the basis of the structured data and the response result, and to convert the indicators into visualization data for a dashboard screen; to display the indicators and the response result as graphs, tables, and summary sentences on the dashboard screen on a display apparatus by using the visualization data, and to update display contents in response to an operation by a user; to acquire a natural-language prompt sentence received from the user via an input terminal, to analyze the natural-language prompt sentence to extract search conditions indicating at least one of an organization unit, a period, target business content, and an output format, to search the structured data and the response result on the basis of the search conditions, and to generate an additional prompt sentence to which a context for input to the generative artificial intelligence model is added on the basis of a search result; and to input the additional prompt sentence to the generative artificial intelligence model and to provide an obtained response to the user via at least one of the display apparatus and an audio output apparatus. This enables an improved computer-implemented processing pipeline that transforms heterogeneous organizational information into structured data, dynamically constructs context-aware prompt sentences, and tightly integrates generative artificial intelligence responses with indexed data and visualization elements, thereby enhancing system-level efficiency, responsiveness, and usability in retrieving, summarizing, and presenting business-related information.

The term “source information” refers to digital information acquired by the system as an input for analysis, including but not limited to audio data, text data, and document data generated within an organization.

The term “meeting audio information” refers to audio data representing spoken content generated during a meeting or conference session, which is to be processed by a speech recognition technique to obtain character information.

The term “text information obtained via a communication means” refers to text data transmitted or received through an electronic communication mechanism, such as messaging tools, email systems, or collaboration platforms, and stored in a form suitable for natural language processing.

The term “non-confidential reference information” refers to digital documents, files, or records that are shared or shareable within an organization without confidentiality restrictions and that are used as input data for deriving business content, issues, and candidate solutions.

The term “speech recognition technique” refers to a computer-implemented process that converts audio data representing human speech into character information or text data using acoustic and language models.

The term “character information” refers to textual data obtained by converting audio data through the speech recognition technique, and represented as sequences of characters or tokens suitable for natural language processing.

The term “natural language processing technique” refers to a set of computer-implemented methods that operate on text data in human language, including, for example, tokenization, sentence segmentation, part-of-speech tagging, syntactic parsing, semantic analysis, and information extraction.

The term “sentence segmentation” refers to a process of dividing a text into individual sentence units based on linguistic rules or statistical models so that subsequent analysis can be applied on a per-sentence basis.

The term “word segmentation” refers to a process of splitting a text or sentence into individual words or tokens according to language-specific rules, thereby enabling further linguistic analysis such as part-of-speech tagging.

The term “part-of-speech tagging” refers to a process of assigning grammatical categories, such as noun, verb, adjective, or adverb, to each token in a text based on its usage and context within the sentence.

The term “syntactic analysis” refers to a process of determining grammatical structure of a sentence by establishing relationships between tokens, such as subject, object, and modifier, typically represented as a parse tree or dependency graph.

The term “descriptions indicating business content, issues, and candidate solutions” refers to portions of text, such as phrases or sentences, that express information about business activities, problems or challenges encountered in such activities, and proposed measures or actions intended to address those problems.

The term “structured data” refers to data that has been transformed from unstructured or semi-structured text into organized records with predefined fields, such as labels, attributes, and indices, enabling efficient storage, retrieval, and analysis.

The term “business content” refers to information describing actions, processes, operations, or tasks performed within an organization, including objectives, activities, and workflows relevant to business execution.

The term “issues” refers to identified problems, obstacles, or deficiencies related to business content, which require attention, resolution, or mitigation.

The term “candidate solutions” refers to proposed measures, actions, or strategies that are intended to resolve or mitigate identified issues in the business content.

The term “frequency information” refers to quantitative data indicating how often particular business content, issues, or candidate solutions appear within the structured data over a given scope or period.

The term “time-series information” refers to data representing temporal aspects of business content, issues, or candidate solutions, including occurrence times, durations, and chronological trends.

The term “affiliation information” refers to data that associates business content, issues, or candidate solutions with organizational entities such as departments, teams, projects, or organizational units.

The term “summary information” refers to condensed representations of business content, issues, and candidate solutions, derived from structured data by aggregation, abstraction, or selection, and organized per organizational unit or time period.

The term “prompt sentence” refers to a natural-language instruction string generated by the system to control behavior of a generative artificial intelligence model, including specifications of requested content, query conditions, and output format.

The term “generative artificial intelligence model” refers to a computer-implemented model that receives one or more prompt sentences as input and generates natural-language or other modality outputs, such as summaries, explanations, or recommendations, based on learned patterns from data.

The term “response result” refers to output generated by the generative artificial intelligence model in response to an input prompt sentence, including natural-language text and optionally additional structured information.

The term “query conditions” refers to parameters contained in or derived from a prompt sentence, such as filters for organization units, time periods, topics, or output styles, which determine the subset of data to be used by the system or by the generative artificial intelligence model.

The term “output format” refers to a specification of how a response result should be structured or presented, such as bullet-point lists, narrative paragraphs, tables, or concise summaries.

The term “indicators” refers to computed measures or metrics that quantify aspects of business states, including occurrence tendencies of issues, proposal states of candidate solutions, and status of business activities for each organization.

The term “visualization data” refers to data structures prepared for rendering indicators and related information on a graphical user interface, including values, labels, and layout parameters used to generate charts, tables, and dashboards.

The term “dashboard screen” refers to a user interface screen that presents visualization data in an integrated layout, such as graphs, tables, and summary sentences, enabling a user to grasp multiple indicators and related information at a glance.

The term “display apparatus” refers to an output device, such as a monitor or display panel, configured to visually present user interface elements, including the dashboard screen and response results.

The term “audio output apparatus” refers to hardware configured to output audio signals, such as speakers or headsets, that can present spoken versions of response results or system notifications to a user.

The term “user operation” refers to an interaction performed by a user via an input device, such as clicking, tapping, typing, or selecting elements on the dashboard screen, which causes the system to update processing or display contents.

The term “input terminal” refers to an electronic device, such as a client computer, mobile device, or terminal apparatus, that provides input mechanisms for a user to send natural-language prompt sentences or commands to the server.

The term “natural-language prompt sentence” refers to a text string expressed in a human language, provided by the user or generated by the system, which describes an information request or instruction in a free-form or semi-structured manner.

The term “search conditions” refers to parameters extracted from a natural-language prompt sentence, specifying constraints such as organization units, time ranges, target topics, and desired output characteristics used to retrieve relevant data.

The term “context for input to the generative artificial intelligence model” refers to supplemental information, such as selected structured data, summary information, or search results, that is combined with or appended to a prompt sentence to guide generation of the response result by the generative artificial intelligence model.

The term “full-text search index” refers to a data structure that stores tokenized text from the structured data along with positional or relevance information, enabling efficient retrieval of records based on keyword or phrase queries.

The term “transition information” refers to metadata associated with elements of a response result, indicating a relationship to one or more visualization screens and enabling navigation from textual content to corresponding dashboard views in response to user selection.

In one embodiment, a server executes a program that implements the claimed system by using general-purpose computer hardware and software components. The server includes at least one central processing unit, a main memory, a non-volatile storage device, a network interface, and a graphics interface. The server executes an operating system such as a general-purpose server operating system, and executes application software written in a high-level language such as a scripting language or a general-purpose programming language. The server communicates with one or more terminals via a network such as an Internet Protocol network. Each terminal includes an input device such as a keyboard or a touch panel and a display apparatus such as a liquid crystal display.

The server uses a storage device to store meeting audio information, text information obtained via communication means, and non-confidential reference information as source information. The server uses an object storage service such as a network-attached storage device or a cloud-based object storage to store audio files in formats such as WAV or MP3.

The server uses a relational database management system such as a general-purpose relational database to store text records, metadata, and structured data. The server further uses a full-text search system such as a text indexing engine to register and search text information.

The server uses speech recognition software to convert meeting audio information into character information. For example, the server uses a cloud-based speech recognition service that implements an acoustic model and a language model based on a deep neural network architecture. The acoustic model may be a convolutional neural network or a recurrent neural network that receives spectrogram features of the audio, such as Mel-frequency cepstral coefficients, as input and outputs phoneme probabilities. The language model may be a transformer-based neural network trained to predict sequences of tokens. The server sends audio data to the speech recognition service via a secure application programming interface and receives recognized text together with confidence scores and time stamps. The server stores the character information and the associated metadata in the relational database.

The server uses natural language processing software to process the character information and the text information obtained from communication means and non-confidential reference information. The server executes a natural language processing library such as a syntactic analysis engine on the operating system. The server performs sentence segmentation to divide text into individual sentences based on punctuation and learned boundaries. The server performs word segmentation and tokenization to split sentences into tokens. The server performs part-of-speech tagging by applying a statistical sequence labeling model such as a conditional random field or a neural sequence tagger. The server performs syntactic analysis using a dependency parser or a constituency parser that outputs grammatical relations between tokens.

The server uses these linguistic features to extract descriptions indicating business content, issues, and candidate solutions. The server stores extraction results as structured data in tables that include, for example, a sentence identifier, a text field, a label field, and feature vectors.

The server may represent each sentence as an embedding vector computed by a neural encoder such as a transformer-based language model. The server calculates similarity between embedding vectors by using a distance metric such as cosine similarity and uses clustering algorithms such as k-means or hierarchical clustering to group similar descriptions. This grouping enables the server to detect recurring issues and recurring candidate solutions in a way that a human operator cannot efficiently perform.

The server classifies sentences into categories such as business content, issues, and candidate solutions by using a classifier model. In one embodiment, the server trains a neural network text classifier on labeled training data. The classifier may be a transformer-based network with an input embedding layer, multiple self-attention layers, and a classification head. The server uses cross-entropy loss as a loss function and updates weights by stochastic gradient descent or an adaptive optimization algorithm. The server stores the trained model parameters in the storage device and loads them into memory for inference. During runtime, the server feeds tokenized text into the classifier and obtains probability scores for each category. The server assigns a label to each sentence based on the highest probability score and stores the label in the structured data.

The server aggregates the structured data to generate summary information. The server calculates frequency information by counting occurrences of issues and candidate solutions across meetings, messages, and documents. The server calculates time-series information by grouping occurrences by time windows such as days, weeks, or months. The server calculates affiliation information by mapping each record to an organizational unit such as a department or a team, based on metadata such as sender address, meeting participants, or document owner. The server stores aggregated results in summary tables that include, for example, counts per issue per time period per organizational unit.

The server automatically generates a prompt sentence for a generative AI model by referring to the structured data and the summary information. The server uses a rule-based template generator to construct a natural-language string that includes query conditions and an output format. For example, the server may generate a prompt sentence such as:
“Summarize, in no more than ten bullet points, the key issues and proposed solutions discussed in the marketing department's meetings during this month, using the following extracted items as factual context: [list of issues and candidate solutions].”

The server can vary the template according to the output format and the type of analysis. The server avoids simply forwarding raw text and instead constructs a context that is filtered, deduplicated, and structured, which reduces the input size for the generative AI model and improves response relevance.

The server uses a generative AI model to generate natural-language responses. In one embodiment, the server accesses a large-scale language model that implements a transformer architecture with multiple self-attention layers, feed-forward layers, and layer normalization. The model is pre-trained on large corpora using unsupervised objectives such as next token prediction or masked language modeling. In some embodiments, the model is fine-tuned on domain-specific text including historical meeting summaries and issue reports. The server communicates with the generative AI model via an application programming interface, sending the prompt sentence and context as input and receiving a response result as output.

The server configures hyperparameters for the generative AI model, such as a temperature parameter to control randomness, a maximum output length, and stop conditions. The server may further use a post-processing module that checks the response for certain constraints, such as the number of bullet points or the presence of required fields. The server associates the response result with the corresponding structured data records, for example by including identifiers inside the context and propagating them through to the response metadata. This association enables traceability between generated text and underlying records.

The server calculates indicators to be visualized on a dashboard. The server computes occurrence tendencies of issues by measuring changes in frequency across time windows and by computing statistical measures such as moving averages or standard deviations. The server computes proposal states of candidate solutions by tracking whether proposed solutions appear in multiple meetings or messages and whether they are associated with follow-up actions. The server computes business states for each organization by aggregating issue severity scores and solution adoption rates. The server converts these indicators into visualization data by mapping each measure to visual encodings such as bar heights, line positions, or color values. The server stores the visualization data in a format suitable for rendering by a charting library or a visualization tool.

The server provides visualization data to the terminal. The server exposes an application programming interface that returns data in a structured format. The terminal receives the data and uses a visualization library, such as a chart rendering library executed in a web browser, to draw graphs and tables on the display apparatus. The terminal displays a dashboard screen that includes, for example, a time-series chart of issue counts, a bar chart of issues per department, and a table listing extracted candidate solutions. When the user interacts with the dashboard, such as by clicking on a bar representing a particular department, the terminal sends a request to the server to fetch more detailed data, and the server responds with filtered structured data and associated response results.

The server acquires natural-language prompt sentences directly from the user via the terminal. The terminal provides an input field in which the user can type free-form queries.

Examples of prompt sentences include:
“Please summarize the key points from this month's marketing meetings.”
“What recurring issues have been identified in the customer support department over the past three months?”
“List the proposed solutions related to onboarding and indicate which ones have been discussed in more than two meetings.”
“Show me a concise bullet-point list of action items decided in last week's engineering meetings.”
“Compare the major issues identified in sales meetings this quarter with those from last quarter.”

The terminal transmits the user's prompt sentence to the server. The server analyzes the prompt sentence by using a natural language understanding module. In one embodiment, the server uses a separate classifier or a smaller language model to extract search conditions such as an organizational unit, a time period, a topic, and a desired output format. The server may implement a rule-based grammar that maps specific expressions such as “this month” or “last quarter” into explicit date ranges and that maps organizational names into internal codes.

The server uses the search conditions to search the structured data and the response results.

The server uses the full-text search index to retrieve relevant sentences and issues efficiently.

The server limits the retrieved data based on pre-defined thresholds to avoid excessive context size, for example by selecting the most recent or most frequent items. The server then constructs an additional prompt sentence that includes both the user's original query and the retrieved context. For example, the server may generate:
“You are an AI assistant helping managers understand organizational issues. Based on the following extracted issues and solutions related to the sales department during the last quarter, answer the user's question: ‘Compare the major issues identified in sales meetings this quarter with those from last quarter.’ Provide a concise comparison highlighting differences and trends. Context: [list of issues and time-stamped summaries].”

The server inputs the additional prompt sentence to the generative AI model and obtains a response. The server provides the response to the user via the terminal, optionally together with links or controls that navigate to related dashboard views. The terminal renders the response as formatted text and presents interactive elements that, when selected, cause the server to load the corresponding visualization data.

The server improves computer technology by optimizing the flow of data between input, processing, and output modules. The server reduces the volume of data sent to the generative AI model by pre-filtering and structuring the context. This reduction decreases communication load and computation time within the model. The server uses full-text indexing and pre-computed embeddings to accelerate retrieval operations, which improves processing speed compared to naive linear scanning of text. The server's structured data representation allows deterministic tracing of generated sentences back to underlying records, which reduces errors and increases reliability relative to conventional systems that rely solely on unstructured text.

The server executes specific algorithms and data structures to achieve these improvements.

The server uses indexing strategies in the relational database to optimize queries based on organizational unit and time ranges. The server uses batch processing to group multiple audio files or text documents, which improves throughput. The server uses caching strategies for frequently accessed summary information and model prompts, which reduces repeated computation. By integrating these elements, the server provides not only automation of human tasks but also a more efficient computational architecture for large-scale textual and audio data analysis.

The server also employs non-conventional processing rules that differ from typical manual workflows. For example, the server uses a combined rule-based and model-based approach to classify issues and candidate solutions, where dependency patterns and lexical cues are used to validate or override model predictions when confidence thresholds are low. This hybrid approach reduces misclassification errors and improves the quality of structured data. The server uses a controlled template system to generate prompt sentences, which systematically encodes query conditions and output preferences, rather than allowing arbitrary free-form queries to reach the generative AI model. This design reduces ambiguity and improves reproducibility of results.

In another embodiment, the server hosts the generative AI model locally, for example on one or more graphics processing units or specialized accelerators. The server stores model weights on a high-speed solid-state drive and loads them into device memory for inference.

The server uses a batching mechanism to process multiple prompt sentences concurrently, which increases hardware utilization and reduces overall latency. The server may implement quantization or pruning techniques to compress the model and reduce memory footprint. The server uses a training pipeline, separate from inference, that fine-tunes the model on anonymized, domain-specific data, using an objective function that penalizes factual inconsistency with the structured data. The server updates model weights by backpropagation and validates performance on a held-out dataset before deploying a new model version.

In yet another embodiment, the server employs alternative generative models such as encoder-decoder architectures or smaller specialized models for summarization and classification. The server may use ensemble techniques, where outputs from multiple models are combined or ranked based on quality scores. The server selects a model variant depending on resource constraints or latency requirements.

In all embodiments, the terminal operates as a thin client that primarily renders user interfaces and transmits user input. The terminal does not perform heavy natural language processing or model inference; instead, the server concentrates computationally intensive tasks. This separation allows centralized optimization of indexing, retrieval, and model serving, and contributes to consistent behavior across multiple user devices.

By integrating speech recognition, natural language processing, structured data generation, full-text indexing, and generative AI model prompting into a single system controlled by the server, the embodiments provide a concrete improvement to computer functionality. The server reduces manual configuration of dashboards by linking generated text with visualization data at the data structure level. The server shortens the path from user queries to relevant, data-grounded answers through optimized retrieval and structured prompts. As a result, the system achieves improved processing speed, reduced communication overhead, enhanced accuracy of extracted information, and more efficient management of large volumes of heterogeneous organizational data.

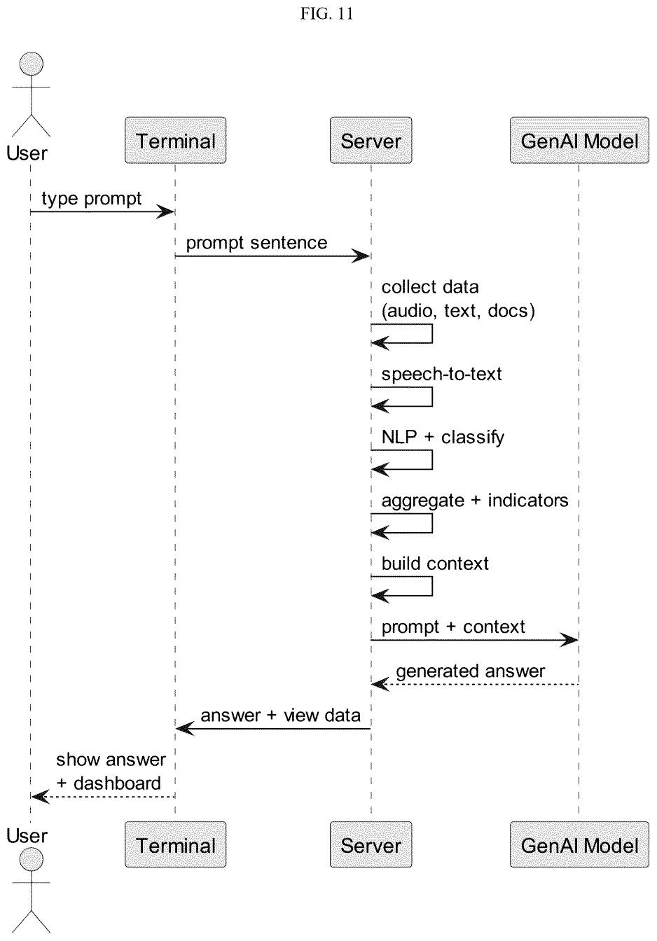

The following describes the processing flow using FIG. 11.

### Step 1:

The server acquires source information.
The server receives, as input, meeting audio files, text messages from communication means, and non-confidential documents via network interfaces and storage APIs. The server calls external service APIs (for example, mail servers, messaging platforms, and file repositories) to download email bodies, chat logs, and document files, and the server writes these raw data objects with metadata (sender, timestamp, file path, department tag) into a storage device and a relational database. The server outputs stored raw records that are registered as source information with unique identifiers.

### Step 2:

The server converts meeting audio information into character information.
The server reads, as input, meeting audio files referenced in the source information. The server sends audio data segments to a speech recognition engine, which applies acoustic and language models to compute probability distributions over token sequences and decodes them into text strings. The server then receives, as output, recognized transcripts with confidence scores and timestamps, and the server stores these transcripts as character information linked to the original meeting audio identifiers in the database.

### Step 3:

The server extracts text from communication messages and documents.
The server takes, as input, text messages and non-confidential documents from the source information table. The server directly parses message bodies as text and uses document parsing libraries to convert document formats into plain text. The server performs data cleaning operations such as removing markup, normalizing whitespace, and decoding character encodings. The server outputs normalized text records for each message or document and stores them in a text corpus table with links to the original source entries.

### Step 4:

The server performs linguistic preprocessing using natural language processing techniques.
The server receives, as input, the character information from meeting transcripts and the normalized text records from messages and documents. The server applies sentence segmentation algorithms to divide each text into sentence units, and the server applies tokenization algorithms to split sentences into tokens. The server runs a part-of-speech tagger and a syntactic parser to compute grammatical tags and dependency structures for each token.
The server outputs annotated sentences that contain tokens, tags, and syntactic relations, and the server stores these annotations in structured tables or serialized feature objects.

### Step 5:

The server identifies business content, issues, and candidate solutions.
The server reads, as input, annotated sentences and their linguistic features from the structured tables. The server applies classification rules and trained models to compute classification scores for each sentence, using features such as token embeddings, dependency patterns, and keyword occurrences. The server labels each sentence as business content, issue, candidate solution, or other based on maximum probability and thresholding. The server outputs labeled sentence records and writes them as structured data containing sentence identifiers, labels, and feature vectors.

### Step 6:

The server aggregates structured data into summary information.
The server takes, as input, the labeled sentence records together with metadata such as timestamps and organizational affiliations. The server executes aggregation operations that group records by organizational unit and time period, and computes counts, frequencies, and co-occurrence statistics for issues and candidate solutions. The server calculates time-series metrics by ordering records chronologically and computing moving averages or trend indicators. The server outputs summary information tables that contain aggregate measures per unit and per period, and stores them in the database for later retrieval.

### Step 7:

The server generates a system-driven prompt sentence for a generative AI model.
The server receives, as input, the summary information and selected subsets of structured data relevant to a particular organizational unit or time range. The server applies a template generation procedure that maps data fields such as top issues, frequent candidate solutions, and key business content into a natural-language instruction string. The server composes a prompt sentence that includes query conditions (for example, department and period) and an output format specification (for example, bullet-point summary). The server outputs the generated prompt sentence and stores it together with a reference to the associated data context.

### Step 8:

The server interacts with the generative AI model using the system-driven prompt sentence.
The server reads, as input, the generated prompt sentence and its structured context. The server packages the prompt and context into a request payload and sends it to the generative AI model endpoint over a network connection. The generative AI model performs internal neural network computations to generate a natural-language response. The server receives, as output, a response result string from the model and may receive additional metadata such as token counts. The server stores the response result in association with the corresponding prompt sentence and structured data identifiers.

### Step 9:

The server computes indicators for visualization.
The server takes, as input, the structured data, the summary information, and the response results from the generative AI model. The server executes computation routines to derive indicators such as issue occurrence tendencies, candidate solution proposal states, and business status metrics per organization. The server performs arithmetic operations and statistical calculations over aggregated data, and maps indicator values into visual parameters such as series data for charts and values for tables. The server outputs visualization data objects that encode these indicators in a format consumable by dashboard components.

### Step 10:

The server provides visualization data to the terminal and updates the dashboard.
The server receives, as input, a dashboard data request from the terminal, which may specify organization unit filters and time ranges. The server queries the visualization data objects and filters them according to the request conditions. The server then outputs a response containing the filtered visualization data and any associated response results, and transmits this response to the terminal. The terminal receives the visualization data and renders graphs, tables, and summary sentences on the display apparatus, updating visual elements according to the newly received data.

### Step 11:

The user enters a natural-language prompt sentence via the terminal.
The user inputs, as input, a free-form natural-language query into an input field rendered on the terminal screen. The terminal captures the text string and may capture additional context such as selected filters or the currently displayed dashboard view. The terminal outputs a request containing the prompt sentence and the context metadata, and sends this request to the server via a network connection.

### Step 12:

The server analyzes the user-provided prompt sentence and derives search conditions.
The server receives, as input, the user's natural-language prompt sentence and any context metadata. The server uses a natural language understanding component to parse the prompt, extracting parameters such as organization unit, time period, topic type (for example, issues or solutions), and desired output form. The server may apply pattern-matching rules and classification models to map phrases like “this month” or “sales department” to concrete date ranges and internal organization codes. The server outputs explicit search conditions and stores them temporarily for the current request.

### Step 13:

The server retrieves relevant structured data based on the search conditions.
The server reads, as input, the extracted search conditions. The server constructs database queries and full-text search queries targeting the structured data, summary information, and previous response results. The server executes these queries to retrieve records that satisfy the organization unit, time range, and topic constraints. The server may rank or filter the retrieved records based on relevance scores or recency. The server outputs a set of relevant data records that will form the factual context for answering the user's prompt.

### Step 14:

The server constructs an additional prompt sentence including retrieved context.
The server takes, as input, the user's original prompt sentence and the retrieved relevant data records. The server formats a composite prompt string that includes an instruction to the generative AI model, the user query, and a compact representation of the retrieved context, such as bullet-point lists of issues and solutions with timestamps and affiliations. The server ensures that redundant or low-relevance items are removed by applying ranking and truncation rules. The server outputs an additional prompt sentence that is optimized for the generative AI model and stores it for logging and traceability.

### Step 15:

The server sends the additional prompt sentence to the generative AI model and receives a response.
The server reads, as input, the additional prompt sentence and any configuration parameters for generation such as temperature and maximum output length. The server submits these to the generative AI model through an inference API. The generative AI model processes the input and returns a generated answer in natural language. The server receives, as output, the generated answer text and may receive associated performance metrics. The server stores the generated answer together with links to the underlying context records.

### Step 16:

The server provides the generated answer and linkage information to the terminal.
The server takes, as input, the generated answer, the linkage information between answer segments and structured data, and references to corresponding visualization data. The server formats a response payload that includes the answer text and metadata for navigation, such as identifiers of relevant indicators and dashboard views. The server outputs this payload to the terminal. The terminal then displays the generated answer to the user and, based on the linkage metadata, renders interactive elements that allow the user to jump from textual elements in the answer to corresponding dashboard graphs or tables.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern production environments, large volumes of heterogeneous operational information are generated continuously in the form of spoken discussions in meetings, text-based communications over various channels, and internal documents with low levels of confidentiality. Conventional computer systems are typically configured to process each of these information sources in isolation and are limited to simple keyword search, static rule engines, or manually crafted templates. As a result, such systems are unable to accurately understand business activities and operational issues across an organization, and cannot automatically generate context-aware improvement proposals for production sites in real time.

Furthermore, known systems that utilize natural language processing often treat text analysis as a one-way batch process. These systems usually do not convert multi-source operational information into structured data that explicitly represents business activities, issues, constraints, and objectives at appropriate units such as processes or facilities. Consequently, the systems cannot construct precise, machine-usable representations of the operational context, and are unable to provide a generative AI model with input that is tailored to the specific conditions of a production site. This leads to generic or impractical recommendations that do not effectively support operators in improving work efficiency.

Additionally, systems that call generative AI models are often implemented as simple front-end interfaces where a user directly inputs prompt sentences. Such systems rely heavily on human expertise to design the prompt sentences, and they do not systematically incorporate operational data analysis or feedback from actual user adoption. Therefore, they cannot achieve consistent quality of generated solutions, and they are unable to adapt the behavior of the generative AI model to the evolving characteristics of the production environment.

Moreover, conventional recommendation systems in factories generally focus on numerical sensor data and prespecified optimization algorithms. They do not integrate unstructured language data such as meeting audio and textual communications, nor do they dynamically update prompt generation logic and structured data organization based on user feedback about which recommendations were accepted or rejected. As a result, the systems cannot improve their own performance over time based on actual operator behavior, and cannot provide refined, high-precision proposals aligned with real-world operational preferences and constraints.

Accordingly, a technical problem exists in that computing resources are not effectively utilized to transform heterogeneous, unstructured operational information into structured context for generative AI processing, and in that prompt generation for the generative AI model is not automatically optimized in accordance with the actual conditions and feedback of the production site. There is thus a need for a computer-implemented technique that (i) converts diverse operational language data into normalized text information, (ii) performs deep natural language analysis to derive structured representations of business activities and issues, (iii) automatically generates prompt sentences for a generative AI model based on such structured data, and (iv) adapts the analysis and prompt generation over time using explicit user feedback regarding the usefulness of generated solutions. By solving these problems, the invention aims to improve the functioning of computer systems that support production site operations, leading to more accurate, actionable, and continuously improving recommendations for work efficiency enhancement.

The specific processing by the specific processing unit 290 of the data processing device 12 in Application Example 1 is realized by the following means.

The present invention provides a server comprising a processor, the processor being configured to acquire original data including meeting sound information, character-based communication information, and low-confidentiality document information, normalize the original data into text information and store the text information in a storage device; to perform, on the text information, natural language processing including morphological analysis, syntactic analysis, and named entity extraction so as to extract business activities, business issues, business constraints, and business objectives, and to organize an extraction result as structured data on a unit basis of a process or a facility; to generate, on the basis of the structured data, a prompt sentence for causing a generative AI model to linguistically express solutions and issues for improving work efficiency in a production site, the prompt sentence including instructions relating to an objective, constraint conditions, and an output format; to input the prompt sentence into the generative AI model and acquire, from the generative AI model, solution information and issue information generated on the basis of the structured data and the prompt sentence; to convert the solution information and the issue information into display data and transmit the display data to a display terminal via a communication network; and to acquire, from the display terminal, adoption information and comment information of a user with respect to the solution information and the issue information, and to update at least one of generation conditions of the prompt sentence and an organization method of the structured data on the basis of the adoption information and the comment information. This enables a computer system to automatically transform heterogeneous operational language data into optimized prompt sentences for a generative AI model, to generate context-aware and practically useful improvement proposals for production sites, and to iteratively refine its own analysis and prompt generation logic based on user feedback, thereby improving the technical performance and adaptability of the computer-implemented support for production operations.

The term “original data” refers to data including meeting sound information, character-based communication information, and low-confidentiality document information that is acquired from one or more information sources as input to the server.

The term “meeting sound information” refers to audio data representing speech uttered during a meeting, discussion, or similar collaborative session, the audio data being suitable for processing by a speech recognition function.

The term “character-based communication information” refers to text information transmitted or received by an electronic communication means, including messages exchanged via electronic mail, chat, or other text-based communication channels.

The term “low-confidentiality document information” refers to document information that is permitted to be shared within an organization without special confidentiality restrictions, and that does not require handling as highly confidential or secret information.

The term “text information” refers to information expressed in a character string format, including information obtained by converting sound information through speech recognition and information originally provided as text, and which is suitable for natural language processing.

The term “normalize” refers to processing that converts heterogeneous data formats into a unified representation, including converting sound information into character strings, unifying character encodings, and arranging data into a common-format data structure.

The term “natural language processing” refers to computerized analysis of text information using techniques such as morphological analysis, syntactic analysis, and named entity extraction to derive linguistic structure and semantic content.

The term “morphological analysis” refers to processing that segments a text sequence into units such as words or morphemes and assigns linguistic attributes such as part-of-speech or basic form to each unit.

The term “syntactic analysis” refers to processing that determines grammatical relationships among words or morphemes in a text, including dependency relations or phrase structures.

The term “named entity extraction” refers to processing that identifies and classifies specific expression units in text, such as names of processes, facilities, products, organizations, or time expressions, as entities with semantic categories.

The term “business activities” refers to operations, tasks, processes, or procedures executed within an organization to achieve production, service, or management objectives.

The term “business issues” refers to problems, bottlenecks, defects, or inefficiencies that negatively affect one or more business activities within an organization.

The term “business constraints” refers to conditions or limitations, such as resource limits, time restrictions, or regulatory requirements, that restrict how business activities are to be performed or how business issues can be solved.

The term “business objectives” refers to target states or goals to be achieved by business activities, including quantitative and qualitative improvement goals such as productivity increase or quality enhancement.

The term “structured data” refers to data that represents at least business activities, business issues, business constraints, and business objectives in a predefined schema or data model, such that the data can be processed systematically by a computer.

The term “unit basis of a process or a facility” refers to a granularity of data organization in which information is grouped and managed with respect to an individual production process, production line, machine, equipment, or similar operational unit.

The term “prompt sentence” refers to a text sequence that is input to a generative AI model, the text sequence including instructions regarding an objective, constraint conditions, and an output format and being designed to cause the generative AI model to generate linguistic expressions of solutions and issues.

The term “generative AI model” refers to an information processing model, implemented using machine learning, that generates natural language text or other data in response to an input prompt sentence and context information.

The term “solutions” refers to proposed actions, procedures, or changes that are intended to address or mitigate business issues and improve work efficiency or other performance measures.

The term “issue information” refers to information describing one or more business issues, including a type of issue, a location or process where the issue occurs, and context related to the occurrence of the issue.

The term “solution information” refers to information describing one or more solutions generated by the generative AI model, including recommended actions, conditions for execution, and expected effects.

The term “display data” refers to data that has been formatted or transformed so as to be suitable for presentation on a display terminal, including layout information, grouping, and conversion into a display protocol or markup language.

The term “display terminal” refers to an electronic apparatus having a display unit and an interface capable of receiving data from the server via a communication network and presenting the data to a user.

The term “adoption information” refers to information indicating whether a user has accepted, rejected, or deferred a particular solution or issue recommendation generated by the system.

The term “comment information” refers to additional textual or symbolic input provided by a user, expressing feedback, evaluation, or supplementary explanations regarding solution information or issue information.

The term “generation conditions of the prompt sentence” refers to parameters, rules, or criteria used by the processor to construct the prompt sentence, including selection of content, ordering of elements, level of detail, and emphasis.

The term “organization method of the structured data” refers to a manner in which structured data is arranged, grouped, prioritized, or filtered for use in generating the prompt sentence or for other processing by the system.

In one embodiment, a server is implemented as an information processing apparatus including at least one processor, a main memory, a nonvolatile storage device, a network interface, and an interface to audio input devices. The server executes an operating system such as a general-purpose server operating system and a runtime environment for a programming language such as a Python interpreter. The server further executes software modules implementing speech recognition, natural language processing, data structuring, prompt generation, communication with a generative AI model, and presentation processing. The server acquires meeting sound information from one or more microphones connected to a personal computer, a dedicated audio interface, or an IP-based audio device installed in a meeting room or a production site. The server uses audio processing software such as a library for audio capture to digitize the sound into a standard audio format such as WAV or FLAC. The server stores the digitized audio in a storage device managed by a file system. In parallel, the server acquires character-based communication information from an electronic mail system and a messaging system. For example, the server accesses an electronic mail server using a mail access protocol and accesses a chat system via an application programming interface to obtain text messages. The server further acquires low-confidentiality document information from a document management system or a shared storage by reading document files and extracting text portions.

The server normalizes these heterogeneous data items into text information. For the meeting sound information, the server uses a speech recognition API provided by a cloud-based speech recognition service such as a generic speech-to-text service. The server transmits audio segments to the speech recognition service, receives character string output, and associates time stamps and speaker identifiers with the recognized text. For the character-based communication information and the low-confidentiality document information, the server converts character encoding to a unified encoding such as UTF-8, removes control characters, and normalizes whitespace and punctuation. The server then stores the normalized text information in a database, for example a relational database management system, in tables that relate each text segment to a meeting identifier, a communication channel, or a document identifier.

The server performs natural language processing on the text information using a natural language processing library such as a general-purpose linguistic analysis library (for example, spaCy) running on the processor. The server loads a language model such as a Japanese or English core model that has been trained using a large corpus and that includes parameters for part-of-speech tagging, syntactic dependency parsing, and named entity recognition. The server applies morphological analysis by segmenting the text into tokens and assigning part-of-speech tags and base forms. The server applies syntactic analysis by constructing dependency trees that represent grammatical relations among tokens. The server performs named entity extraction by classifying token spans into semantic categories such as process names, equipment identifiers, product names, organization names, and time expressions.

The server derives business activities, business issues, business constraints, and business objectives by applying rule-based and machine-learned classifiers on top of the linguistic analysis results. For example, the server evaluates sentence-level features such as the presence of verbs related to failure, delay, or stoppage combined with equipment entities, and assigns such sentences to a “business issue” category. The server evaluates sentences mentioning target values or improvement goals and assigns such sentences to a “business objective” category. The server further detects business constraints by identifying sentences that contain expressions relating to limited resources, time limits, or prohibited operations.

The server aggregates these extracted elements and organizes them into structured data in the form of records that reference specific processes, lines, or facilities.

The server structures the extracted information in a data model that groups data by units such as production processes or facilities. For each process or facility, the server maintains a structured record that includes fields for known business activities, associated business issues with occurrence frequencies, business constraints, and business objectives. The server updates these records as new text information is processed. The server may store the structured data in a document-oriented database or as structured entries in the relational database, using schemas that support efficient retrieval by process or facility.

The server generates a prompt sentence for a generative AI model based on the structured data. The server maintains prompt generation rules in a configuration repository. The server selects a prompt template depending on the type of support required, such as identifying bottlenecks, proposing maintenance measures, or creating an action plan for the next work shift. The server fills the template with structured data elements, such as a list of frequent issues, the corresponding processes or facilities, and relevant constraints and objectives. The server also includes explicit instructions relating to the objective, constraint conditions, and output format, for example by requesting bullet lists, stepwise instructions, or short operator-oriented sentences. Because the server uses structured data to select and order content, the prompt sentence is adapted to the specific technical context of the production site. For example, the server may generate the following prompt sentence:
“Act as a manufacturing process improvement specialist. Based on the following context extracted from our factory meetings, emails, and chat messages, identify the main bottlenecks and propose specific, practical solutions. Consider that we cannot hire additional staff this month, and we must avoid production stops longer than 30 minutes.

### Context:

Machine B in Process A frequently stops for minor adjustments (average 8 short stops per shift).
Changeover time in Process C is 35 minutes on average.
Final inspection often creates a queue, causing a delay of 20 minutes per batch.
   Using this context, generate:
1. A list of key issues with short explanations.
2. For each issue, 2-3 concrete solutions that can be implemented within the existing workforce.
3. A brief action plan for the next 8-hour shift.
Use clear, concise language that can be understood by operators on the factory floor.”

The server then transmits the prompt sentence to a generative AI model. In one embodiment, the generative AI model is implemented as a transformer-based neural network with multiple attention layers. The model includes an encoder-decoder architecture with a plurality of self-attention heads in each layer, feed-forward sublayers, and layer normalization. The model parameters consist of weight matrices and bias vectors trained on large corpora of text by minimizing a loss function such as cross-entropy between predicted tokens and ground-truth tokens. During inference, the model receives the prompt sentence as a sequence of tokens, applies positional encoding, and propagates activations through the attention layers and feed-forward layers to compute output token probabilities. The model uses sampling or greedy decoding to generate an output text that expresses solutions and issues corresponding to the context.

In another embodiment, the generative AI model is executed on an inference server that includes one or more graphics processing units. The inference server exposes a network-based application programming interface that the main server calls over a secure communication channel. The main server sends the prompt sentence and optional context parameters such as maximum output length and temperature. The inference server processes the request using the neural network, and returns the generated text as a response. The main server receives the generated solution information and issue information and associates them with the structured data records used for prompt generation.

The server converts the generated solution information and issue information into display data tailored for a display terminal. The server formats the generated text into a markup language such as HTML and organizes the content into sections such as “Summary of Issues,” “Recommended Solutions,” and “Action Plan.” The server may add metadata obtained from the structured data, for example, linking each recommended solution to a process identifier or equipment identifier. The server transmits the display data to one or more terminals via a network. The terminals can be personal computers, tablet devices, or handheld terminals that include a display and an input interface.

The terminal receives the display data over the network and renders it using a web browser or a dedicated application. The terminal displays lists of issues and corresponding solutions, along with indicators such as severity level or expected improvement. The user operating in a production site, such as an operator or a supervisor, uses the terminal to inspect the recommendations. The user can input adoption information by selecting options such as “accept,” “reject,” or “defer,” and can enter comment information describing reasons for the decision or additional constraints, for example, “maintenance can only be performed during the night shift.”

The terminal sends the adoption information and comment information back to the server via the network. The server receives this feedback and stores it in a feedback data structure associated with the corresponding structured data and prompt sentence. The server then updates the generation conditions of the prompt sentence and the organization method of the structured data. For example, the server adjusts weights that determine which types of business issues are more likely to be included in future prompt sentences, based on acceptance rates. The server may also adjust grouping or prioritization logic so that issues associated with repeatedly rejected solution types are deprioritized or presented with alternative solution styles.

The server thereby implements an adaptive feedback loop that improves the quality and relevance of prompt sentences over time. Because the server modifies internal parameters used for selecting structured data elements and arranging them into prompt sentences, the system gradually reduces the generation of low-utility solutions and increases the proportion of proposals that are accepted by users. This adaptation improves the technical performance of the computer system by reducing unnecessary communication with the generative AI model, decreasing processing overhead for unhelpful suggestions, and focusing computational resources on high-value content.

In order to support this adaptation, the server executes an analysis module that periodically computes statistics such as adoption rates per issue type, rejection reasons, and comment patterns. The server may use a machine learning model, such as a logistic regression classifier or a shallow neural network, trained on past feedback to predict the likelihood that a candidate issue-solution pair will be accepted. The server incorporates these predictions into the prompt generation process by giving higher priority to content with higher predicted acceptance rates. This results in improved calculation efficiency, as fewer iterations of query and response with the generative AI model are needed to obtain practically useful solutions.

The server further improves technical performance in terms of processing speed and accuracy by precomputing certain linguistic features and storing them in the structured data. For instance, the server may compute vector representations of sentences using an embedding model and cache these vectors. When processing new text information, the server compares sentence embeddings to existing ones to detect similar issues. This similarity computation allows the server to reuse previously validated solution patterns instead of always invoking the generative AI model, thereby reducing communication load and accelerating response time.

The server also employs data structures optimized for rapid retrieval and update. For example, the server may use an index keyed by process identifier and issue category, allowing constant-time or logarithmic-time retrieval of all issues related to a particular process. When generating a prompt sentence, the server uses this index to quickly select the most recent and frequent issues. Because the prompt sentence is constructed from a small, relevant subset of the entire data, the prompt length is reduced, leading to faster processing by the generative AI model and reduced network traffic.

In one embodiment, the server uses a hybrid rule-based and neural approach to classify business issues and objectives. The server defines domain-specific patterns that capture typical linguistic expressions in the production environment, such as sequences of verbs and equipment entities that indicate stoppages or quality deviations. The server applies these patterns to the output of the natural language processing library. In parallel, the server runs a trained classifier that uses features derived from token sequences, part-of-speech tags, and dependency paths. By combining both approaches, the server improves classification accuracy beyond what a purely manual or purely statistical method could achieve. This contributes to a more precise structured data representation, which in turn improves the quality of the prompt sentences and the subsequent generative outputs.

In another embodiment, the server uses a variant of a transformer architecture as the generative AI model, trained specifically on manufacturing and operational texts. The model is trained using supervised fine-tuning on domain-specific datasets, where input contexts and expected solution texts are paired. The server or an external training apparatus optimizes model parameters by minimizing a loss function that measures the difference between generated tokens and reference tokens, using gradient-based optimization such as stochastic gradient descent with regularization. The server may further apply reinforcement learning from human feedback, where user adoption information is used to assign rewards to generated solutions, and the model is fine-tuned to maximize expected reward. This training methodology improves the model's ability to generate solutions that align with practical requirements, reducing the number of irrelevant or low-quality suggestions.

The server can also operate in configurations where different generative AI models are selected based on context. For example, the server may utilize a smaller, low-latency model for short, real-time prompts and a larger, more accurate model for comprehensive analysis tasks. The server manages a model-selection logic that takes into account the size of the structured data, the urgency of the request, and available computational resources. By doing so, the server optimizes computational efficiency, ensuring that processing speed and accuracy are balanced according to the operational needs of the production site.

The terminal may be realized as an industrial tablet mounted near a production line or as a workstation in a control room. The terminal displays actionable information that is directly connected to control operations. For example, when the server identifies a bottleneck related to a particular piece of equipment, the terminal may provide an interface through which the user can send commands to a separate control system that adjusts machine parameters or schedules maintenance. While such control systems may be managed by dedicated industrial controllers, the present system improves the upstream information processing that determines which control actions should be taken, thereby providing a technical contribution to the overall control-flow architecture.

The user interacts with the terminal to provide feedback that the server uses to refine its internal models and prompt generation rules. Because this feedback is used not merely to log business decisions but to alter machine-level parameters governing data selection, classification thresholds, and prompt construction, the system achieves a technical improvement in how the computer processes and prioritizes information. The server thus leverages user feedback to reduce misclassifications, improve relevance scores, and shorten the time required to produce actionable output, which are all technical effects within the computer system.

In alternative embodiments, the server may employ different natural language processing libraries, different database technologies, or different neural network architectures, as long as the server performs the essential functions of normalizing heterogeneous data into text information, extracting and structuring business activities and issues, generating prompt sentences for a generative AI model based on the structured data, and updating prompt generation conditions and structured data organization based on user feedback. The specific combination of these functions, implemented as concrete processing steps on the server, yields a system that transcends a mere automation of human judgment and instead improves the technical functioning of the computer in handling, organizing, and exploiting complex language data in a production environment.

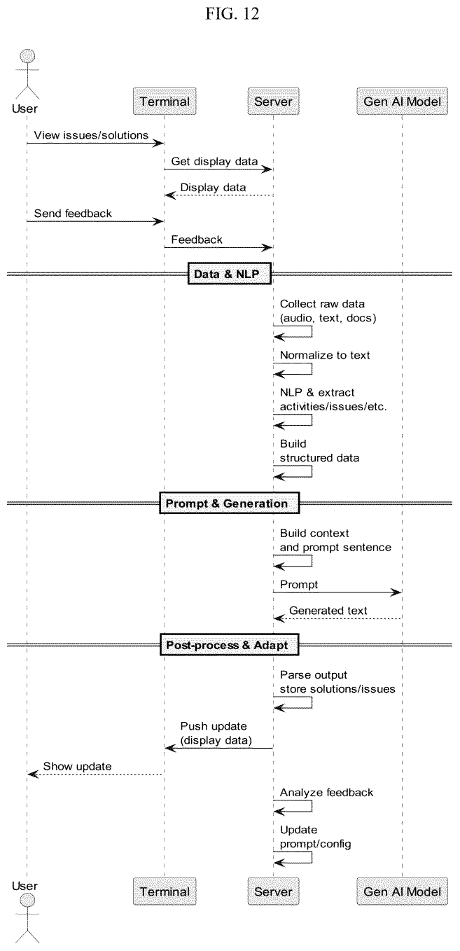

The following describes the processing flow using FIG. 12.

### Step 1:

The server acquires original data. The server receives, as input, meeting sound information from microphones or audio devices, character-based communication information from mail servers and chat systems, and low-confidentiality document information from document repositories. The server converts incoming audio streams into digital audio files, queries communication systems via APIs to obtain message bodies and metadata, and reads document files from storage. The server writes the raw audio files and text data into a storage device so that all heterogeneous sources are collected in a unified data acquisition layer. The output of this step is a set of stored raw audio files and raw text records associated with identifiers such as meeting IDs, communication channel IDs, and document IDs.

### Step 2:

The server normalizes the original data into text information. The server takes, as input, the raw audio files and raw text records produced in Step 1. The server calls a speech-to-text service to convert the meeting sound information into character strings, and performs character encoding conversion and cleaning on all text sources. Concretely, the server sends audio segments to a speech recognition API, receives recognized text with time stamps, and removes non-textual noise markers. The server then applies encoding normalization (for example, to UTF-8), removes control characters, and standardizes whitespace across emails, chat messages, and document text. The output of this step is normalized text information stored in a text table or collection, where each entry has a unified encoding and is linked to a source identifier and time information.

### Step 3:

The server performs basic linguistic analysis on the text information. The server reads, as input, the normalized text records from Step 2. The server loads a natural language processing library and applies morphological analysis to segment the text into tokens, syntactic analysis to build dependency structures, and named entity extraction to label mentions of processes, facilities, products, organizations, and time expressions. During this processing, the server computes part-of-speech tags, lemmatizes words, and assigns entity types based on learned models and rule patterns. The output of this step is an enriched linguistic dataset in which each sentence is associated with tokens, grammatical relations, and named entity annotations, all stored as structured records in a linguistic analysis data structure.

### Step 4:

The server detects business activities, business issues, business constraints, and business objectives. The server uses, as input, the linguistic analysis data from Step 3. The server applies rule-based patterns and trained classifiers to each sentence or phrase, using features such as verb categories, dependency relations, and entity types. The server classifies sentences mentioning failure, stoppage, delay, or defects combined with equipment or process entities as business issues, and identifies sentences expressing targets or desired performance as business objectives. The server similarly recognizes expressions of limitations in time, budget, or resources as business constraints and extracts descriptions of normal work procedures as business activities. The output of this step is a set of labeled semantic elements, each tagged as activity, issue, constraint, or objective and associated with the original text and linguistic context.

### Step 5:

The server organizes the semantic elements into structured data by process or facility. The server receives, as input, the labeled semantic elements from Step 4. The server groups elements based on process identifiers, facility identifiers, or line identifiers detected from named entities and metadata. The server aggregates occurrences of similar issues, counts their frequencies, and attaches measures such as impact scores based on co-occurrence with severe outcome terms. The server builds structured records that, for each process or facility, list business activities, issues with frequency and impact, relevant constraints, and objectives. The server stores this structured data in a database with an index on process and facility keys. The output of this step is a structured dataset ready for prompt construction, where the operational context is represented in a machine-usable format.

### Step 6:

The server prepares contextual summaries for prompt generation. The server takes, as input, the structured data records generated in Step 5. The server selects a target process or facility based on user configuration, current time window, or detected activity, and extracts the most relevant issues and objectives for that target. The server then compresses and summarizes these items into concise textual descriptions, such as short sentences indicating issue type, frequency, and affected equipment. The server may limit the number of items to meet token constraints. The output of this step is a context summary text that succinctly represents the operational situation for a specific process or facility.

### Step 7:

The server generates a prompt sentence for a generative AI model. The server uses, as input, the context summary from Step 6 and prompt generation rules stored in configuration data. The server selects a template corresponding to the desired task, such as root-cause analysis or action planning, and inserts the context summary and explicit instructions into the template. The server specifies an objective (for example, improving line throughput), constraint conditions (for example, no additional staffing and limited downtime), and an output format (for example, numbered lists with short explanations). The output of this step is a completed prompt sentence that is precisely tailored to the structured operational context and the required response format.

### Step 8:

The server sends the prompt sentence to the generative AI model and receives generated text. The server takes, as input, the prompt sentence created in Step 7. The server transmits the prompt sentence via an API call to a generative AI model implemented as a transformer-based neural network hosted either locally or on a remote inference server. The server includes parameters such as maximum number of output tokens and sampling temperature in the request. The generative AI model processes the tokenized prompt through its attention layers and feed-forward layers to compute probability distributions over output tokens and returns generated text that contains solution information and issue information. The server receives this generated text as the output of this step and stores it with a link to the corresponding prompt and context.

### Step 9:

The server post-processes the generated text into structured solution information and issue information. The server uses, as input, the raw generated text output from Step 8. The server parses the text to detect headings, numbered lists, and bullet points and aligns each suggested solution with references to processes or facilities mentioned in the context. The server may apply additional keyword and entity matching to associate each recommendation with a specific issue category and operational unit. The server then creates structured records for each recommended action, including fields such as target process, equipment, required resources, and expected impact. The output of this step is a set of machine-readable solution information and refined issue information derived from the generative AI model's response.

### Step 10:

The server converts the solution information and issue information into display data and transmits it to the terminal. The server accepts, as input, the structured recommendation records from Step 9. The server formats these records into display-oriented data structures, such as HTML fragments or JSON objects designed for rendering. The server organizes content into sections like “Key Issues,” “Recommended Countermeasures,” and “Short-Term

Action Plan,” and includes visual indicators such as severity labels and priority rankings. The server sends the resulting display data to the terminal via a network protocol such as HTTPS. The output of this step is a transmitted payload that the terminal can directly present to the user.

### Step 11:

The terminal receives and renders the display data. The terminal uses, as input, the payload sent by the server in Step 10. The terminal's browser or application interprets the markup or structured data to construct user interface elements such as lists, tables, and icons. The terminal lays out the issues and solutions, associates them with checkboxes or buttons for user actions, and refreshes the display when new data arrives. The output of this step is a visual representation on the terminal's display, making the generated recommendations and contextual information accessible to the user.

### Step 12:

The user reviews the displayed information and inputs feedback. The user takes, as input, the visual presentation on the terminal from Step 11. The user inspects the listed issues and proposed solutions, evaluates their practicality, and interacts with interface elements to record decisions. The user may, for each recommendation, select an adoption status such as acceptance, rejection, or deferral, and may type free-text comments explaining reasons, constraints, or alternative ideas. The output of this step is a set of feedback data elements representing the user's adoption decisions and comments entered through the terminal interface.

### Step 13:

The terminal transmits the user feedback to the server. The terminal takes, as input, the feedback data elements created in Step 12. The terminal packages these elements into a request, including identifiers of the related issues and solutions, and sends the request over the network to a feedback endpoint provided by the server. The terminal may use a secure HTTP POST operation to transmit the data. The output of this step is a feedback message delivered to the server, containing structured adoption information and comment information for each evaluated recommendation.

### Step 14:

The server records and analyzes the user feedback. The server uses, as input, the feedback message from Step 13. The server stores each feedback entry in a feedback table linked to the corresponding structured data and generative output. The server then performs data analysis, such as computing acceptance rates for different issue categories or solution types, and identifying common reasons for rejection mentioned in comments. The server may compute statistical measures or train simple predictive models using features such as issue category, solution type, and past acceptance history. The output of this step is an updated set of feedback statistics and, optionally, updated model parameters that characterize user preferences and real-world effectiveness.

### Step 15:

The server updates prompt generation conditions and structured data organization based on the analyzed feedback. The server accepts, as input, the feedback statistics and model parameters calculated in Step 14. The server modifies weights and rules in its prompt generation logic, for example increasing the probability of including solution styles that historically exhibit high acceptance and decreasing emphasis on those frequently rejected. The server may also refine grouping and prioritization strategies in the structured data, such as promoting issues with high impact and high acceptance-probability solutions to the top of future context summaries. The server writes the updated configuration into a persistent store so that subsequent executions of Steps 5 through 7 use the refined rules. The output of this step is a modified internal configuration that causes future prompt sentences and structured selections to be better aligned with user preferences and operational constraints, improving the system's technical performance over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computing systems for processing meeting records and business communications typically require a human operator to manually review audio recordings, text messages, and document files, then manually identify business-relevant information such as issues and proposed solutions. Even where automated transcription and keyword search are available, such systems usually treat speech recognition, natural language processing, and report generation as disjoint tasks, without an integrated control flow that transforms heterogeneous input data into structured, machine-usable business information. As a result, the processor resources of such systems are not effectively utilized: duplicate parsing is performed, task-specific heuristics are reimplemented across applications, and the overall latency and reliability of information extraction depend heavily on user interaction and manual tuning.

Furthermore, known systems that interface with generative information processing models (such as large-scale neural language models) often rely on static, manually crafted prompt sentences. These prompt sentences are not automatically adapted to the actual content of the underlying business data, which limits the precision and consistency of the generated summaries or recommendations. The processor in such systems is not architected to systematically analyze raw source data, extract structured business information, and derive context-specific prompt sentences that direct the generative model to perform targeted summarization or supplementation. Consequently, the generative model is frequently underutilized as a component of a larger computing pipeline, and the resulting outputs may omit critical issues or misrepresent organizational priorities.

In addition, conventional report-generation workflows typically treat the output of a generative model as an unstructured text block that must be manually edited and reorganized into a formal business report. The processor does not automatically integrate extracted business information, issue information, and solution information with the generative model's response, nor does it store such integrated results in a form that can be easily indexed, retrieved, and consumed by terminal devices in an enterprise environment. This lack of tight coupling between data ingestion, analysis, model interaction, and document structuring leads to inefficiencies in storage usage, difficulties in downstream processing, and increased error rates in the produced reports.

Accordingly, there is a need for an improved computer-implemented system in which a processor is specifically configured to: (i) receive heterogeneous source data including audio data, text data, and non-confidential document data; (ii) invoke a speech recognition technique to normalize audio data into text; (iii) apply layered natural language processing to extract structured business information, issue information, and solution information; (iv) automatically generate context-aware prompt sentences for a generative information processing model; (v) integrate the model's response with the extracted information; and (vi) construct and store structured business report document data that can be efficiently accessed by terminal devices. Such an arrangement improves the functioning of the computer system itself by reducing redundant processing, optimizing the usage of external services, and enabling consistent, automated generation of high-quality business reports from complex, multi-modal input data.

The specific processing by the specific processing unit 290 of the data processing device 12 in Example 2 is realized by the following means.

The present invention provides a server comprising a processor configured to receive source data including audio data, text data, and non-confidential document data; convert the audio data included in the source data into text data by using a speech recognition technique; analyze the source data and the text data by using a natural language processing technique to perform sentence segmentation, word segmentation, part-of-speech tagging, syntactic parsing, phrase extraction, and classification processing, and thereby extract business information, issue information, and solution information related to an organization; generate, based on the extracted business information, issue information, and solution information, a prompt sentence requesting a generative information processing model to summarize or supplement the business information, the issue information, and the solution information; input the generated prompt sentence and the extracted information to the generative information processing model and acquire response information from the generative information processing model; and generate business report document data by using the extracted information and the response information, store the business report document data in a storage area, and make the business report document data referable from a terminal device. This enables an integrated and automated computing workflow in which heterogeneous business data are normalized, semantically analyzed, and transformed into structured report documents through coordinated interaction between the processor, external recognition services, and a generative information processing model, thereby improving the efficiency, accuracy, and technical performance of the computer system in extracting and presenting business-relevant information.

The term “system” refers to a combination of hardware and software components including at least one processor, a storage resource, and one or more communication interfaces, which cooperate to execute the functions described in the claims.

The term “processor” refers to one or more hardware processing units, such as a central processing unit or a graphics processing unit, capable of executing instructions to perform arithmetic, logic, and control operations.

The term “information processing apparatus” refers to an electronic device or group of devices that process digital data, including but not limited to servers, client devices, and networked computing equipment.

The term “source data” refers to a collection of input data including audio data, text data, and non-confidential document data that are provided to the information processing apparatus for analysis.

The term “audio data” refers to digital data representing sound signals, such as recordings of speech from meetings, calls, or other voice communications.

The term “text data” refers to digital data in the form of character strings or documents that are already represented as human-readable text at the time of input.

The term “non-confidential document data” refers to digital document data that are not designated as confidential or restricted, such as publicly shareable reports, manuals, or emails.

The term “speech recognition technique” refers to a computerized process that converts audio data representing spoken language into text data using algorithms for acoustic analysis and language modeling.

The term “text data conversion” refers to the process of transforming audio data into corresponding text data by means of the speech recognition technique.

The term “natural language processing technique” refers to a collection of algorithms and software procedures that analyze text data in human language to perform operations such as tokenization, parsing, and semantic interpretation.

The term “sentence segmentation” refers to the process of dividing a body of text into discrete sentence units based on punctuation, syntax, or learned patterns.

The term “word segmentation” refers to the process of dividing text into individual word units or tokens, which may include handling of language-specific rules.

The term “part-of-speech tagging” refers to the process of assigning syntactic category labels, such as noun, verb, or adjective, to words or tokens in text data.

The term “syntactic parsing” refers to the process of analyzing the grammatical structure of a sentence to determine relationships among words or phrases.

The term “phrase extraction” refers to the process of identifying and extracting multi-word expressions or meaningful phrase units from text data based on syntactic or statistical criteria.

The term “classification processing” refers to the process of assigning one or more predefined categories or labels to units of text, such as sentences or phrases, according to their content or function.

The term “business information” refers to information in the text that describes organizational activities, goals, decisions, operations, or other work-related content.

The term “issue information” refers to information in the text that describes problems, risks, obstacles, or deficiencies related to organizational activities or processes.

The term “solution information” refers to information in the text that describes proposed countermeasures, responses, plans, or actions intended to address issues or achieve business objectives.

The term “generative information processing model” refers to a machine-learning-based computational model that generates text or other data outputs in response to input data and prompt sentences, including but not limited to large language models.

The term “prompt sentence” refers to a text string that instructs or guides the generative information processing model regarding what type of output to produce from given input data.

The term “summarize” refers to the process of producing a condensed representation of information that preserves key points or essential content from the original data.

The term “supplement” refers to the process of adding explanatory, clarifying, or elaborative information to existing data, based on inferences or learned patterns of the generative information processing model.

The term “response information” refers to data output by the generative information processing model in response to a prompt sentence and associated input information.

The term “business report document data” refers to structured or semi-structured digital document data that describe business information, issue information, and solution information in a report format.

The term “storage area” refers to a physical or logical memory resource, such as a disk drive, solid-state drive, or network storage, in which digital data can be stored and retrieved.

The term “terminal device” refers to an end-user computing device, such as a personal computer, tablet, or smartphone, that communicates with the server to access or display data.

The term “external information processing service” refers to a network-accessible computing service provided by a third-party or separate computing environment, which performs specialized processing such as speech recognition or generative modeling.

The term “program library” refers to a software component or collection of routines and data structures that can be called by a program to perform specific processing, such as morphological analysis, syntactic analysis, or semantic analysis.

The term “morphological analysis” refers to the process of decomposing text into morphemes and determining grammatical features such as base forms and inflections.

The term “semantic analysis” refers to the process of determining meanings, roles, or semantic relationships of words and phrases within a text.

The term “generative information processing engine” refers to an implementation of a generative information processing model that is deployed on computing resources and accessible via an interface, such as an application programming interface.

The term “meeting records” refers to data representing content of meetings, including transcripts, notes, or other textual representations of spoken discussions.

The term “display device” refers to any hardware component capable of visually presenting information to a user, such as a monitor, screen, or projector.

The term “audio output device” refers to any hardware component capable of outputting sound to a user, such as a speaker or headphone.

The term “user” refers to a human operator or person who interacts with the system via a terminal device or interface to provide input data or receive output data.

In one or more embodiments, a server executes a program that is stored in a non-transitory computer-readable storage medium and that causes a processor to perform an integrated sequence of data reception, speech recognition, natural language processing, interaction with a generative AI model, and structured document generation. A terminal and a user cooperate with the server to provide input data and consume generated results.

The server is implemented, for example, as a rack-mounted computing apparatus including a multicore central processing unit, a main memory, a non-volatile storage device, and a network interface. The server runs an operating system such as a general-purpose server operating system and a runtime environment for executing application programs written in a high-level language such as a scripting language or a virtual-machine-based language. The terminal is implemented, for example, as a personal computer, a tablet device, or a smartphone including a processor, a display device, a pointing device or touch screen, an audio input device, an audio output device, a memory, and a wireless or wired communication interface. The user operates the terminal to provide data to the server and to view or listen to report document data output by the server.

The server uses a server-side application framework (for example, a web application framework) to expose an application programming interface for receiving source data from the terminal. The server uses an external speech recognition service such as a generic cloud-based speech-to-text service to convert audio data to text data, and uses a natural language processing library such as a general-purpose tokenization and parsing library for syntactic and semantic analysis. The server further uses an external generative AI model interface, such as a cloud-based large language model service, to which the server sends a prompt sentence together with extracted information and from which the server receives response information that is incorporated into a business report.

The server receives, as source data, digital audio files, digital text files, and digital document files that are not designated as confidential. The server stores the received data in a storage area, such as a relational database or a file system, in association with metadata indicating an organization identifier, a meeting identifier, a time stamp, and a data type identifier. The server converts file-level data into internal data structures. For example, the server represents each meeting as a record having fields for a list of utterances, each utterance having a speaker identifier, a start time, an end time, and text content. The server represents each sentence as an element in a sentence list, each element storing a token list, part-of-speech tags, dependency arcs, and semantic labels.

The server uses a speech recognition subsystem to convert audio data into text data. The server forms a sequence of audio frames by reading the audio file in fixed-length segments and optionally applying pre-processing such as noise reduction and normalization. The server submits the audio frames or a pointer thereto to an external speech recognition engine via a network call. The external engine internally uses an acoustic model and a language model to compute, for each frame sequence, a probability distribution over phonetic units and then over word sequences; however, the server does not depend on the internal architecture of the external engine. The server receives, from the external service, a sequence of words and punctuation markers with associated time stamps and confidence scores. The server stores the recognized text as transcript data in the storage area and associates each utterance with the original audio segment.

The server applies a natural language processing subsystem to the transcript data and any pre-existing text data and non-confidential document data. The server uses a tokenizer from the natural language processing library to convert each sentence into a sequence of tokens.

The server uses a part-of-speech tagger to assign a grammatical category to each token. The server uses a syntactic parser to generate, for each sentence, a dependency tree or constituency tree that identifies the grammatical relations between tokens. The server uses a named-entity recognizer to detect terms corresponding to business entities such as organizations, products, time expressions, and numerical values. The server further computes vector representations (embeddings) for each sentence or phrase using a pre-trained representation model such as a transformer-based encoder; these embeddings are numerical feature vectors that capture semantic similarity in a high-dimensional space.

The server uses these structured representations to extract business information, issue information, and solution information. The server maintains a classification model that maps each sentence or phrase to one of multiple categories, including but not limited to business information, issue information, and solution information. In one embodiment, the server implements this classification model as a neural network having a transformer encoder followed by a feedforward classification head. The server inputs a tokenized sentence to the encoder, obtains a contextual embedding for the sentence, and applies a linear transformation with a softmax function to output a probability distribution over categories. The server selects the category with the highest probability as the label for the sentence, provided that the probability exceeds a threshold. The server stores the labeled sentence, its category, its embedding, and its position index in a structured record format.

The server trains the classification model on previously collected labeled data. The server uses a supervised learning process in which training examples consist of sentences from historical transcripts and labels assigned by experts. The server uses a cross-entropy loss function comparing predicted category probabilities with ground truth labels, and updates network weights by gradient descent with a variant such as Adam optimization. The server optionally uses regularization techniques such as dropout and weight decay, and data augmentation techniques such as paraphrase generation or synonym replacement to increase robustness. By training the model in this manner, the server enables the processor to recognize nuanced variations in how issues and solutions are expressed, which improves classification accuracy compared to simple keyword-based approaches.

The server generates a prompt sentence for a generative AI model based on the extracted business information, issue information, and solution information. The server composes the prompt sentence by following a template that includes a task description, structural instructions, and selected content snippets. For example, the server generates a prompt sentence such as:
“From the following meeting transcript, extract the key business information, problems, and solutions, and summarize them in clear bullet points. Separate sections as ‘Business Information’, ‘Problems’, and ‘Solutions’. Transcript:
[TRANSCRIPT_TEXT]”
   or
“Analyze the meeting text below and create an executive summary highlighting goals, issues, proposed countermeasures, and next actions. Use concise bullet points and clear headings.

### Transcript:

[TRANSCRIPT_TEXT]”.

The server may also generate a prompt sentence that focuses more on structured extraction, such as:
“From the following conversation, list all problem statements and corresponding solution proposals that are mentioned or implied. Transcript:
[TRANSCRIPT_TEXT]”.

The server selects and arranges content to include in the prompt based on the classification results and embeddings. For example, the server may choose only sentences labeled as issue information or solution information, and may cluster similar sentences using a similarity metric over embeddings to avoid redundancy. The server thereby constructs a prompt sentence that is not static but dynamically adapted to the specific content of the meeting, which is a distinct technical behavior compared to conventional manually crafted prompts.

The server transmits the prompt sentence and associated extracted information to a generative AI model. In one embodiment, the generative AI model is a transformer-based language model hosted on an external computing service. The model includes multiple self-attention layers, each computing attention weights over token positions and generating contextualized representations. The server encodes the prompt sentence and any appended data as token identifiers using a tokenizer defined for the model. The server sends the tokenized sequence and configuration parameters, such as a maximum token length, a sampling temperature, and a top-k or top-p value, to the external model service via a network interface. The server receives, as response information, a sequence of tokens representing a generated explanation, summary, or structured list of items.

Although the generative AI model executes on external hardware, the server controls the flow of information in a manner that improves overall computation on the server side. The server constrains the prompt length through sentence selection and compression so as to reduce network bandwidth and latency and to keep server memory consumption stable. The server uses the classification labels and embeddings not only to create the prompt sentence but also to map generated sentences back to internal data structures. For example, the server can align generated bullet points with original sentences via semantic similarity in embedding space and can discard inconsistent model outputs. As a result, the server reduces the amount of erroneous or irrelevant text that would otherwise require human correction, thereby improving overall system accuracy and resource utilization.

The server integrates the response information from the generative AI model with the previously extracted business information, issue information, and solution information to generate business report document data. The server creates a document object that includes multiple sections, such as an overview section, a section listing business information, a section listing issue information, and a section listing solution information. The server populates these sections with sentences or bullet points from both the extracted information and the generated response. The server may further apply template-based formatting using a document template that defines heading styles, bullet list formats, and table structures. The server renders the document as a structured format, such as a markup language, which is then converted to a display-oriented format such as a portable document format.

The server stores the generated business report document data in the storage area with an index keyed by meeting identifier and time stamp. The server updates an index or search structure so that a query specifying a topic, a time range, or a category can retrieve the corresponding report efficiently. The server may compress the document data, store a hash value for integrity verification, and record links from the report to underlying source data elements, thereby improving data management and traceability.

The terminal accesses the generated business report document data from the server. The terminal displays a list of available reports, including titles, creation times, and brief summaries, based on metadata obtained from the server. The user selects a report via a graphical user interface. The terminal downloads the selected report and renders the structured sections as visual elements on the display device. The terminal may also convert the text content to speech and output it via the audio output device, enabling auditory consumption of the report.

In this system, the server improves computer technology rather than merely automating human reading and summarizing tasks. By tightly coupling speech recognition, natural language processing, classification, prompt generation, and generative modeling in a controlled pipeline, the server reduces redundant parsing and duplicate representation conversions. The server maintains internal data structures such as sentence embeddings, category labels, and alignment mappings that allow efficient reuse of intermediate results. This architecture reduces processing time for subsequent operations on the same or related data and enables incremental updates when new source data are added.

The server also improves accuracy in extracting issue information and solution information by combining rule-based filtering and learned classification. Traditional manual approaches rely on subjective reading, whereas simple keyword-based systems fail to capture context. By contrast, the server's classification model leverages contextual embeddings and supervised learning, trained with an explicit loss function and weight update mechanism, to separate similar phrases into distinct categories. This reduces classification error rates and leads to more reliable identification of actionable content.

Further, the server reduces communication load and computation on the generative AI model side by sending tailored prompt sentences that include only relevant and pre-filtered content. This not only lowers the amount of data transmitted over the network but also reduces the token length processed by the generative model. As a result, response times are shortened and processing cost is reduced, which is a concrete technical effect directly tied to the server's prompt generation and data selection algorithms.

The server differs from a simple automation of human work by using internal metrics, such as classification confidence scores and embedding-based similarity thresholds, to decide which sentences to include or exclude in prompts and reports. The server can, for example, discard sentences whose maximum category probability falls below a threshold, and can automatically resolve conflicts where two sentences are highly similar but assigned differing labels. This is not a direct emulation of human judgment but a distinct rule set and processing path that exploits numeric features and network-trained weights.

In alternative embodiments, the server can use different types of classification models, such as a convolutional neural network applied to token embeddings, or a recurrent neural network architecture such as a bidirectional long short-term memory network. The server may also incorporate additional features, such as speaker identity, time position in the meeting, or document section position, into the classification input. The server may use different optimization algorithms during training, such as stochastic gradient descent with momentum or adaptive learning rate schedules. The server may further adjust the loss function to weight certain categories, such as issue information, more heavily than others, thereby biasing the model toward recall of important problem statements.

The server can also use different generative AI models, including models with encoder-decoder architectures or models specialized for summarization. The server can adjust generation parameters to favor determinism or creativity, depending on the use case. The server may additionally perform post-processing on the generated text, such as grammatical correction or consistency checking against an ontology of business terms. These variations still fall within the scope of the described embodiments as long as the server continues to receive heterogeneous source data, perform multi-stage analysis to extract structured information, generate prompt sentences for a generative AI model, and integrate the model's response into structured business report document data.

By configuring the server in the above manner, the system provides a concrete improvement in the way computing devices process and transform multi-modal business communication data. The system enhances processing speed, improves extraction and summarization accuracy, reduces storage and communication overhead, and generates structured outputs that are more easily consumed by terminal devices. These technical effects arise from specific data structures, model training procedures, algorithmic steps, and module interconnections within the computer system, rather than from a mere change in business policy or a generic instruction to “use AI.”

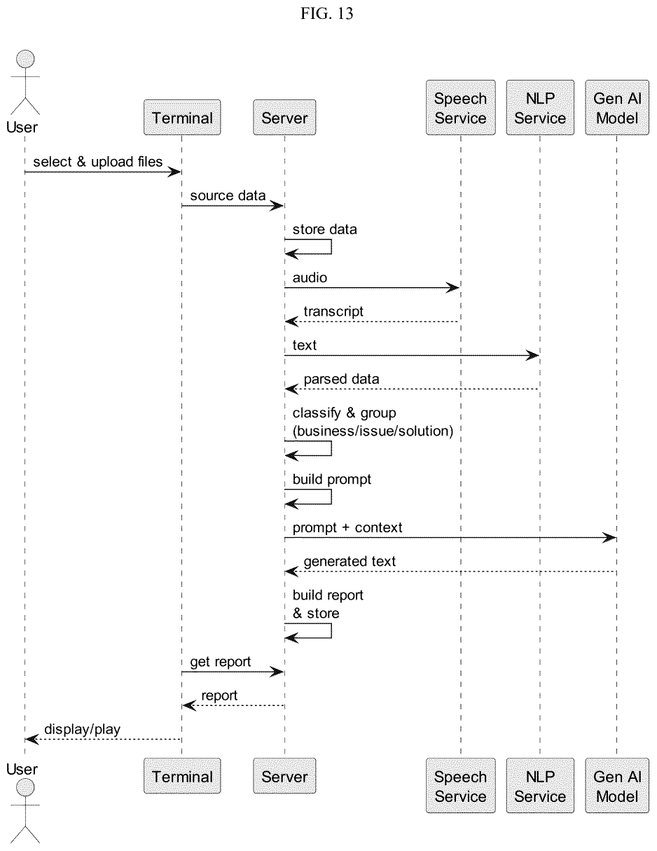

The following describes the processing flow using FIG. 13.

### Step 1:

The user operates the terminal to provide source data to the server.
The user selects one or more files on the terminal, such as an audio file of a meeting, a text file of messages, or a document file that is not confidential, and triggers an upload operation through a graphical user interface.
The terminal reads the selected files from local storage, attaches metadata such as file type, meeting title, and language code, and sends the source data to the server over a network using an application protocol.
The input of Step 1 is raw source data residing on the terminal, and the output of Step 1 is a network request containing the source data that is delivered to the server.

### Step 2:

The server receives and stores the source data.
The server accepts the network request from the terminal, parses the request headers and payload, and separates audio data, text data, and non-confidential document data based on file type and metadata.
The server assigns a unique identifier to each upload session, creates database records for the session and for each file, and writes the files into a storage subsystem such as a file system or an object store.
The input of Step 2 is the network request containing the source data, and the output of Step 2 is a set of stored data objects and associated metadata records that can be referenced by identifiers in subsequent processing.

### Step 3:

The server converts audio data into text data by using a speech recognition technique.
The server retrieves stored audio files from the storage subsystem, reads the audio bytes, and segments the audio into frames or chunks if needed.
The server sends the audio content or references to the audio content to an external speech recognition engine, specifying parameters such as sampling rate, language code, and encoding format.
The server receives recognition results from the external engine, including recognized words, sentence boundaries, and confidence scores, and joins the recognized segments into one or more transcript strings associated with each audio file.
The input of Step 3 is stored audio data, and the output of Step 3 is transcript text data that represent the spoken content of the audio in a machine-readable text form.

### Step 4:

The server normalizes and aggregates text data.
The server collects transcript text data generated in Step 3, pre-existing text data uploaded in Step 1, and text extracted from non-confidential documents by using text extraction tools such as document parsers.
The server concatenates or links these text segments into a logical document for each meeting or session, and performs normalization operations such as lowercasing, Unicode normalization, whitespace trimming, and punctuation standardization.
The input of Step 4 is heterogeneous text fragments from multiple sources, and the output of Step 4 is a unified normalized text representation for each session that is ready for natural language processing.

### Step 5:

The server performs natural language processing on the unified text.
The server uses a natural language processing library to segment the unified text into sentences and to tokenize each sentence into words or subword units.
The server applies part-of-speech tagging, syntactic parsing, and named-entity recognition to each sentence, generating a structured representation that includes token lists, grammatical tags, dependency relationships, and entity spans.
The server may also compute numerical feature vectors (embeddings) for each sentence or phrase by applying a pre-trained encoder model.
The input of Step 5 is the normalized unified text, and the output of Step 5 is a set of structured linguistic representations and feature vectors for each sentence and phrase.

### Step 6:

The server classifies sentences into business information, issue information, and solution information.
The server feeds the feature vectors and possibly additional features such as position in the document into a trained classification model, which may be a neural network or another machine learning model.
The server computes, for each sentence, a probability distribution over predefined categories and assigns the category with the highest probability if the probability exceeds a threshold; the server may also flag low-confidence sentences for secondary handling.
The server writes classification results, including sentence identifiers, assigned categories, and confidence values, into a structured data store.
The input of Step 6 is the set of structured linguistic representations and feature vectors from Step 5, and the output of Step 6 is a labeled set of sentences divided into business information, issue information, and solution information categories.

### Step 7:

The server filters and organizes extracted information for downstream use.
The server retrieves the labeled sentences from the data store and applies filtering rules to remove duplicates, near-duplicates, or sentences with low classification confidence.
The server groups sentences by category and, if necessary, orders them based on temporal position, importance scores, or semantic similarity clustering so that related items are placed together.
The input of Step 7 is the labeled sentence set from Step 6, and the output of Step 7 is a cleaned and organized collection of business information, issue information, and solution information for each session.

### Step 8:

The server generates a prompt sentence for a generative AI model.
The server selects representative sentences from the organized collection in Step 7, for example by taking the highest-confidence items or cluster centroids, and composes them into a context section.
The server combines a task description template with this context section to form a prompt sentence that instructs the generative AI model on how to summarize or supplement the information.

For example, the server may construct a prompt sentence such as:
“From the following meeting transcript, extract the key business information, problems, and solutions, and summarize them in clear bullet points. Separate sections as ‘Business Information’, ‘Problems’, and ‘Solutions’. Transcript:
[TRANSCRIPT_TEXT]”.
The input of Step 8 is the organized collection of categorized sentences, and the output of Step 8 is a prompt sentence tailored to the specific content of the session.

### Step 9:

The server sends the prompt sentence and related data to the generative AI model.
The server tokenizes the prompt sentence and any appended content according to the vocabulary of the target generative AI model, sets generation parameters such as maximum token count and sampling temperature, and constructs a model input payload.
The server issues a request to an external generative AI service, transmitting the tokenized payload via a network interface, and waits for a response that contains generated tokens or text.
The input of Step 9 is the prompt sentence and selected contextual content from Step 8, and the output of Step 9 is response information produced by the generative AI model, typically in the form of generated text.

### Step 10:

The server post-processes and validates the response information from the generative AI model.
The server converts the generated tokens into text if necessary, segments the response into sentences or bullet points, and aligns the generated segments with the original categorized sentences using similarity measures on embeddings.
The server checks the response for consistency with categorized items, removes segments that do not align with any original content or violate predetermined constraints, and annotates the remaining segments with references to underlying source sentences.
The input of Step 10 is the raw response information from the generative AI model, and the output of Step 10 is a validated and annotated set of generated summaries and recommendations.

### Step 11:

The server generates business report document data from extracted and generated information.
The server constructs a document structure with sections such as overview, business information, issues, and solutions, and populates each section with a combination of classified original sentences and validated generated text.
The server applies formatting rules, fills a report template, and converts the structured content into a document format such as a markup document or a printable document, and stores the resulting business report document data in the storage subsystem.
The input of Step 11 is the organized categorized sentences from Step 7 and the validated response segments from Step 10, and the output of Step 11 is a finalized business report document that is linked to the original session identifier.

### Step 12:

The terminal retrieves and presents the business report document data to the user.
The terminal sends a request to the server specifying a session identifier or report identifier, receives metadata and the corresponding report document data, and downloads the document.
The terminal renders the report on a display device, presenting the structured sections and summaries, and optionally converts the text to audio for playback through an audio output device so that the user can review the report content.
The input of Step 12 is a user-selected report identifier and the stored business report document data retrieved from the server, and the output of Step 12 is a visual or auditory presentation of the report that the user can consume on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that analyze meeting audio, communication logs, and shared documents typically perform isolated transcription or keyword extraction and then require a human operator to manually interpret the results, draft task descriptions, and prepare reports or guidance. Such systems do not provide an integrated, machine-executable pipeline that (i) converts heterogeneous source data into normalized textual representations, (ii) structurally understands business-related content and associated emotional context, and (iii) programmatically generates well-formed prompt sentences for a generative artificial intelligence model in a way that is tailored to different downstream tasks such as summarization, topic extraction, solution proposal, or response-guideline generation. Because prompt sentences for generative artificial intelligence models are often handcrafted per use case, the quality and consistency of generated outputs depend heavily on individual human expertise. This leads to several technical problems in a computing environment: (1) high latency and processing overhead due to manual prompt design and manual triage of issues; (2) inconsistent encoding of contextual information such as sentiment, importance, and business category, which causes unstable model behavior and unpredictable responses; and (3) difficulty in automatically prioritizing time-sensitive or negative-emotion content for real-time notification to user devices.

Further, conventional systems generally lack a feedback-controlled mechanism that couples emotion analysis with importance scoring to drive real-time notification and adaptive generation behavior. As a result, computing resources may be consumed on low-priority content while high-priority problem-related content or customer dissatisfaction remains buried in large volumes of unstructured data. This leads to suboptimal utilization of processing resources, increased user cognitive load when reviewing system outputs, and reduced effectiveness of automated decision support.

Accordingly, there is a need for an improved computer-implemented system that, using a processor, (i) unifies reception and state management of heterogeneous source data, (ii) automatically performs speech recognition and layered natural language and emotion analysis to produce structured business content with importance scores, (iii) automatically generates task-specific prompt sentences embedding this contextual information for a generative artificial intelligence model, and (iv) selectively structures and delivers the generated results, including immediate notification of high-priority content to user devices. Such a system should reduce manual configuration, stabilize and improve the quality of model outputs, and enhance the efficiency and responsiveness of the overall computing workflow.

The specific processing by the specific processing unit 290 of the data processing device 12 in Application Example 2 is realized by the following means.

The present invention provides a server comprising a processor configured to receive source data including audio information related to meetings, character information related to communications, and sharable record information, to store the source data in a storage resource together with management information indicating a processing state for each item of the source data, and to manage the processing state of the source data; to convert audio information included in the source data into character information by using a speech recognition technique and to perform natural language processing on the character information including segmentation, part-of-speech tagging, syntactic analysis, and phrase extraction so as to extract, based on a result of the natural language processing, business-related content, resolution-related content, and problem-related content; to evaluate the extracted character information by using an emotion analysis technique, to determine polarity and an emotional state of utterance content, to reclassify, based on a determination result, the business-related content as the resolution-related content or the problem-related content, and to calculate an importance degree of each piece of content; to organize contextual information including the extracted and reclassified business-related content, the resolution-related content, the problem-related content, the emotional state, and the importance degree, and to generate a prompt sentence for a generative artificial intelligence model by embedding the contextual information into a predetermined instruction format that is selected from a plurality of templates corresponding to task types including a summary generation task, a topic extraction task, a solution proposal task, and a response-guideline generation task; to transmit the prompt sentence to the generative artificial intelligence model, to obtain a response content from the generative artificial intelligence model, and to structure the response content as at least one of report information, list information, notification information, or guidance information, including selecting, based on the importance degree and the emotional state, problem-related content or dissatisfaction-related content concerning a customer as high-priority content and generating notification information for immediate delivery; and to convert the structured response content into an output format as display information or voice output information, to provide the output-format information and the notification information to a user device having a display function or a voice output function, and to cause the user device to present corresponding information to a user. This enables an integrated, computer-implemented pipeline that automatically transforms heterogeneous communication and meeting data into structured, emotion-aware business content, programmatically generates optimized prompt sentences for a generative artificial intelligence model according to task-specific templates, and selectively delivers prioritized results, thereby reducing manual configuration and triage, stabilizing model behavior, improving responsiveness for high-priority issues, and enhancing the overall efficiency and technical performance of the information processing system.

The term “system” refers to a combination of at least one hardware resource and at least one software resource configured to cooperate to execute the processing steps described in the claims, including at least a processor and one or more storage or communication resources.

The term “processor” refers to one or more hardware processing units, such as a central processing unit or a programmable logic device, configured to execute instructions that implement the functions described in the claims, either alone or in cooperation with other components.

The term “source data” refers to data received by the system as input for analysis, including but not limited to audio information, character information, and record information that represent communication, meeting, or business activities.

The term “audio information” refers to data representing sound signals in digital form, including speech produced during meetings or conversations and recorded or streamed to the system.

The term “character information” refers to text data composed of characters or symbols representing language content, including messages, transcripts, documents, and other textual records.

The term “sharable record information” refers to non-confidential document data, log data, or other record data that can be shared within or across organizations without confidentiality restrictions and that is usable as input to the system.

The term “storage resource” refers to any hardware and software combination capable of storing data persistently or temporarily, including memory, storage devices, and associated management software such as databases or file systems.

The term “management information” refers to metadata associated with each item of source data, including at least an identifier, a processing state, timestamps, and optionally user or context identifiers.

The term “processing state” refers to status information indicating a stage of processing applied to a particular item of source data, such as a state of reception, transcription, analysis, prompt generation, model response acquisition, or delivery.

The term “speech recognition technique” refers to a computational method or algorithm configured to convert audio signals containing speech into corresponding character information.

The term “natural language processing” refers to a set of computational techniques that operate on character information representing human language to analyze, interpret, and extract linguistic structures and meanings.

The term “segmentation” refers to a natural language processing operation that divides character information into units, such as sentences, clauses, or tokens, for further analysis.

The term “part-of-speech tagging” refers to an operation that assigns grammatical categories, such as noun, verb, or adjective, to tokens contained in character information.

The term “syntactic analysis” refers to an operation that determines structural relationships among tokens in character information, including dependency relationships and phrase structures.

The term “phrase extraction” refers to an operation that identifies compound linguistic units, such as noun phrases or verb phrases, from character information based on syntactic or statistical criteria.

The term “business-related content” refers to portions of character information that describe activities, processes, states, or facts concerning an organization's operations or work.

The term “resolution-related content” refers to portions of character information that describe actions, plans, or measures intended to solve, mitigate, or improve issues or tasks associated with business-related content.

The term “problem-related content” refers to portions of character information that describe issues, risks, complaints, or deficiencies associated with business-related content.

The term “emotion analysis technique” refers to a computational method configured to derive emotion or sentiment information from character information, including polarity and emotional attributes.

The term “polarity” refers to a classification value indicating whether an utterance or text segment has a positive, negative, or neutral evaluative orientation.

The term “emotional state” refers to a classification of emotion associated with an utterance or text segment, including but not limited to positive, negative, neutral, or more fine-grained categories such as satisfaction, dissatisfaction, or anxiety.

The term “importance degree” refers to a computed measure that indicates a relative priority or significance of content, derived based on at least one of emotional state, occurrence context, and semantic category.

The term “contextual information” refers to a structured aggregation of data elements related to analyzed content, including at least business-related content, resolution-related content, problem-related content, emotional state, and importance degree.

The term “generative artificial intelligence model” refers to a computational model configured to generate natural language text or other content based on input instructions and context, including models that predict sequences of tokens conditioned on prompt information.

The term “prompt sentence” refers to a sequence of character information that encodes an instruction, context, or constraint and is supplied to a generative artificial intelligence model to specify a task and influence generated output.

The term “instruction format” refers to a structural pattern of character information used to organize contextual information and directive language into a form suitable for use as a prompt sentence.

The term “template” refers to a predefined instruction format including placeholders that are filled with contextual information to generate a specific prompt sentence for a particular task.

The term “task type” refers to a category of processing to be performed by the generative artificial intelligence model, including at least summary generation, topic extraction, solution proposal, and response-guideline generation.

The term “summary generation task” refers to a task type in which the generative artificial intelligence model is requested to produce a condensed representation of content while preserving key information.

The term “topic extraction task” refers to a task type in which the generative artificial intelligence model is requested to identify and express primary themes or subjects from contextual information.

The term “solution proposal task” refers to a task type in which the generative artificial intelligence model is requested to generate suggested actions or measures for addressing problem-related content.

The term “response-guideline generation task” refers to a task type in which the generative artificial intelligence model is requested to generate phrases, scripts, or patterns for responding to another party, such as a customer or colleague.

The term “response content” refers to output data generated by the generative artificial intelligence model in response to a prompt sentence, including any summary, list, instructions, proposals, or scripts.

The term “report information” refers to response content structured into a format resembling a document or report, suitable for review by a user.

The term “list information” refers to response content structured as a set of ordered or unordered items, such as lists of issues, actions, or topics.

The term “notification information” refers to response content that is formatted and designated for use in alerting or informing a user in a timely manner, including short messages or alerts.

The term “guidance information” refers to response content that contains instructions, recommendations, or suggested behaviors that guide a user's actions.

The term “output format” refers to a data structure or encoding suitable for presentation by a user device, including formats for visual display or audio output.

The term “display information” refers to output-format data suitable for presentation on a visual interface, such as a screen or graphical display.

The term “voice output information” refers to output-format data suitable for conversion into audible sound by a voice output mechanism.

The term “user device” refers to an external device operated by or accessible to a user, including at least a device having a display function or a voice output function, such as a computing terminal or communication terminal.

The term “high-priority content” refers to problem-related content or dissatisfaction-related content that has an importance degree exceeding a predetermined threshold or meeting predetermined selection conditions.

The term “dissatisfaction-related content” refers to problem-related content that reflects a negative emotional state or complaint, particularly in connection with a customer or counterpart.

The term “immediate delivery” refers to a transmission operation in which notification information or other prioritized information is sent to a user device with reduced delay upon detection of high-priority content.

In one embodiment, a server implements the claimed system as a network-connected computing apparatus including at least one processor, a main memory, a non-volatile storage device, and a communication interface. The server runs an operating system such as a general-purpose server operating system and a middleware stack including a web application framework, a database management system, and a set of machine learning libraries. The server configures the processor to execute software modules that implement reception and management of source data, speech recognition, natural language processing, emotion analysis, importance scoring, prompt sentence generation, communication with a generative AI model, and generation of output information.

The server uses a relational database management system, such as a structured query language database engine, as a storage resource for management information and structured analysis results. The server uses an object storage service or file system as a storage resource for raw audio and large document files. The server defines tables for source data records, processing states, textual segments, emotion scores, importance degrees, and generated outputs. Each source data record includes fields such as a source identifier, data type, creation time, user identifier, and a processing state field that indicates whether transcription, analysis, prompt generation, and model response acquisition have been completed.

The server receives source data from a terminal over a communication network using a web application framework such as a Python-based web framework. The server establishes an application programming interface endpoint that accepts audio files or streams in a standardized audio format and character information such as messages and documents. The server writes the received data into the storage resource and inserts a corresponding row into the source data table with the processing state set to an initial value. The server thereby enables systematic tracking of the processing of heterogeneous inputs without manual intervention.

The server uses a speech recognition module to convert audio information into character information. In one embodiment, the server calls an external speech recognition service via its application programming interface. The server sends the audio waveform data together with parameters such as sampling rate, language code, and diarization flags. In another embodiment, the server runs an on-premise acoustic model implemented as a deep neural network with a sequence-to-sequence architecture or a hybrid acoustic model. The server uses feature extraction such as Mel-frequency cepstral coefficients or log-mel spectrograms and decodes the output using a beam search algorithm with a language model. By standardizing the representation of audio as character information, the server reduces downstream computational complexity, because all later modules operate on text rather than on high-dimensional audio signals.

The server applies natural language processing to the character information. The server uses a natural language processing library that provides tokenization, part-of-speech tagging, syntactic dependency parsing, and named entity recognition. The server loads a language model trained on large corpora and executes it on the processor to obtain token-level and sentence-level annotations. The server constructs data structures such as token arrays, dependency trees, and entity lists, and stores them as serialized objects or structured fields in the database. Because these structures provide explicit grammatical relations and semantic entities, the server is able to compute feature vectors that capture non-trivial patterns, such as co-occurrence of specific verbs with specific entities and positional relationships within sentences.

The server implements an emotion analysis module that computes polarity and emotional state for each textual segment. In one embodiment, the server uses an external sentiment analysis service through an application programming interface. In another embodiment, the server runs an internal neural network classifier. The server configures this classifier as a multi-layer neural network with an input embedding layer, several transformer or recurrent layers, and a final softmax output layer. The server converts each sentence into a sequence of token embeddings, applies multi-head attention to capture long-range dependencies, and computes a probability distribution over emotion labels. The server stores, for each segment, numeric scores for positive, negative, neutral, and optional specialized emotions such as “frustration” or “confidence.” By storing both raw probabilities and discrete labels, the server can later adjust decision thresholds and importance scoring without re-running the classifier.

The server calculates an importance degree for each piece of content using a rule-based scoring algorithm and, in some embodiments, a learned regression model. The server considers features such as the presence of time-critical terms, the emotion probabilities, the frequency of occurrence of similar content across multiple meetings, and references to specific entities such as customers or production lines. The server computes a weighted sum of these features and normalizes the result to a fixed range. Because the importance calculation is executed automatically and uniformly, the server can prioritize high-impact segments for further processing and notification, thereby reducing processing load and bandwidth usage on content that is unlikely to require immediate user attention.

The server organizes contextual information by combining business-related content, resolution-related content, problem-related content, emotional state, and importance degree into a structured representation. The server models this contextual information as a hierarchical structure, for example, a segment object containing text fields, tag fields, emotion fields, and numeric importance values, and a higher-level document object aggregating multiple segments. The server uses this structured representation to determine, for each document, which segments should be included in a prompt sentence for a generative AI model.

The server generates prompt sentences by selecting a template corresponding to a task type and filling placeholders with contextual information. In one embodiment, the server stores multiple templates as text strings containing marker tokens such as “[ISSUES_LIST]” or “[POSITIVES_LIST].” The server selects a summary template when the goal is to condense content, a topic extraction template when the goal is to identify themes, a solution proposal template when the goal is to derive countermeasures, and a response-guideline template when the goal is to create scripts for interaction. The server populates each placeholder with text constructed from the structured content, such as bullet lists of high-importance problem-related content or concise representations of positive outcomes. This template-based generation ensures consistent encoding of context across different invocations of the generative AI model, which in turn stabilizes the distribution of generated outputs and reduces variance caused by ad-hoc human prompt design.

For example, the server may generate the following prompt sentence for topic extraction from a meeting transcript:
“From the following transcript of a meeting, extract topics that the user might be interested in and list them as concise bullet points:
‘Recently, there was a discussion about the evolution of AI technology. In particular, applications of generative AI models and blockchain in supply-chain optimization were highlighted.’”

In another example, the server may generate the following prompt sentence for business strategy verbalization:
“Using the keywords and phrases below, verbalize the sales department's new customer acquisition strategy in clear business language, suitable for publication on an internal portal:

Keywords: ‘social media marketing,’ ‘new customer acquisition,’ ‘Instagram and LinkedIn campaigns,’ ‘manufacturing SMBs,’ ‘lead nurturing.’
Please produce one coherent paragraph.”

In a further example, the server may generate the following prompt sentence for factory-line improvement:
“A worker reported: ‘The production line A is too slow and we may miss the delivery deadline.’
Based on this statement and the following context (bottleneck at machine X, frequent micro-stops, quality rechecks at the end), propose concrete improvement measures to increase throughput and reduce delay risk.
Output a numbered list of actionable steps for line operators.”

The server transmits the generated prompt sentence and associated context to a generative AI model. In one embodiment, the generative AI model is implemented as a transformer-based neural network with multiple layers of self-attention, trained on large-scale text corpora to predict next tokens given preceding tokens. The server passes parameters such as temperature, maximum output length, and sampling strategy. The server receives the generated sequence of tokens representing the model's response content. Because the server uses consistent templates and structured context, the generative model can more reliably output machine-parseable structures (for example, clearly separated items), which simplifies downstream structuring of the response content.

The server structures the response content as report information, list information, notification information, or guidance information. The server parses the generated text, identifies headings and list markers, and segments the content into logical units stored in a response table. The server associates each response unit with its originating source data and with segment-level emotion and importance metadata. When the importance degree and emotion state for a unit indicate high-priority problem-related or dissatisfaction-related content, the server generates notification information that contains a concise title and summary. The server then formats report information and guidance information as display information by rendering them into mark-up or other display-ready formats.

The server provides the converted output information and notification information to terminals operated by users. The server uses communication protocols to push notifications to mobile terminals, desktop terminals, or wearable terminals. The server also exposes endpoints that terminals can poll to obtain full reports or lists upon user request. The terminal, which may be a smartphone, a tablet, a desktop computer, or a pair of smart glasses, runs an application that displays the information on a graphical interface or renders voice output using a text-to-speech engine. In factory scenarios, the terminal optionally controls a robotic device by converting guidance information into control commands, such as instructions to display particular procedure steps on a robot-mounted display or to play audio instructions through speakers. In this way, the information generated by the system is used to influence physical processes in the real world rather than merely generating abstract text.

In one embodiment, the server improves processing speed and reduces resource usage by implementing non-traditional control flow that differs from a simple linear pipeline. The server uses a job scheduler that evaluates the importance degree and emotion state before invoking the generative AI model. The server bypasses generative processing for segments with low importance and neutral emotion, or batches multiple such segments into a single prompt to reduce network overhead. For high-priority segments, the server executes a fast-path pipeline that reuses cached embeddings and pre-computed features, reducing latency before notification is sent. These control decisions are made by deterministic logic rather than human operators, which enables consistent and repeatable performance improvements.

In another embodiment, the server tunes the generative AI model interface based on feedback from user interactions. The server logs which suggestions users accept or ignore, and uses this data to adjust template wording, selection of contextual fields, and threshold values for importance. The server thereby implements a systematic optimization loop that refines the prompt generation algorithm as a technical process, improving the match between generated content and user needs and reducing the frequency of irrelevant outputs. This optimization goes beyond simple automation of human writing, because it exploits internal statistical patterns of the generative model and systematically adjusts machine-level parameters and text structures to shape model behavior.

The server achieves improvements in data management by maintaining fine-grained processing states and structured representations. For each item of source data, the server records distinct states such as “received,” “transcribed,” “analyzed,” “prompt generated,” “model responded,” and “delivered.” This enables the server to resume processing after failures, parallelize independent stages, and efficiently reprocess only those items affected by updated models or templates. By using normalized data structures for tokens, segments, emotions, and importance degrees, the server minimizes duplication and facilitates targeted queries, such as retrieving all negative high-importance segments from a particular time period. This leads to improved computation efficiency and reduced storage overhead compared with ad-hoc logging of unstructured text.

In a further embodiment, the server implements the emotion analysis and importance scoring using a hybrid rule-and-model approach. The server uses explicit rule sets that detect domain-specific patterns, such as occurrences of time-critical terms, risk terms, or customer references. The server combines these rule-based scores with neural network outputs to derive final importance degrees. This hybrid approach differs from conventional sentiment-only classifiers and introduces non-standard decision rules that are specifically adapted to drive the downstream prompt generation and notification mechanisms. As a result, the system can focus computing resources on content that is not only emotionally negative but also structurally indicative of risk or operational impact.

The terminal cooperates with the server to enhance technical performance. For example, the terminal can perform local pre-processing of audio, such as noise reduction and voice activity detection, before uploading audio segments. This reduces bandwidth usage and improves transcription accuracy, because the server receives cleaner signals. The terminal can also cache recently received report fragments and only request incremental updates from the server, lowering communication load. The server and terminal thereby coordinate to optimize resource utilization across the networked environment.

The user interacts with the system primarily through the terminal interface. The user can select which categories of notifications to receive, provide feedback indicating whether a generated suggestion is useful, and annotate specific outputs as erroneous. The server uses this feedback not to change business rules but to refine internal parameters controlling prompt sentence generation, importance thresholds, and error handling logic. Because the refinement is applied at the level of data structures and algorithms, rather than merely altering content superficially, the system as a whole adapts its computational behavior and improves over time as a technical apparatus.

In alternative embodiments, the server may use different generative AI architectures, such as encoder-decoder transformers or large recurrent networks, or may deploy multiple models specialized for different languages or domains. The server may also vary the emotion analysis model, using convolutional neural networks, recurrent networks, or support vector machines trained on domain-specific data. The server may implement the generative AI model locally within the same physical server, or may connect to a remote computational cluster through a low-latency communication interface. In each case, the server maintains the same logical sequence of operations: structured analysis and classification, context organization, task-specific prompt sentence generation, and structured use of the model's response to drive prioritized notifications and outputs.

By orchestrating these modules and data flows, the server realizes a technical improvement to computer-based information processing. The system does not merely replicate human reading and writing, but imposes structured representations, algorithmic scoring, and template-based prompt construction to control the behavior of a complex generative AI model in a repeatable, resource-efficient manner. The server thereby improves processing speed for urgent content, enhances accuracy in identifying and communicating critical issues, and reduces computational and communication overhead compared with conventional systems that lack such integrated, rule-guided, and model-aware control mechanisms.

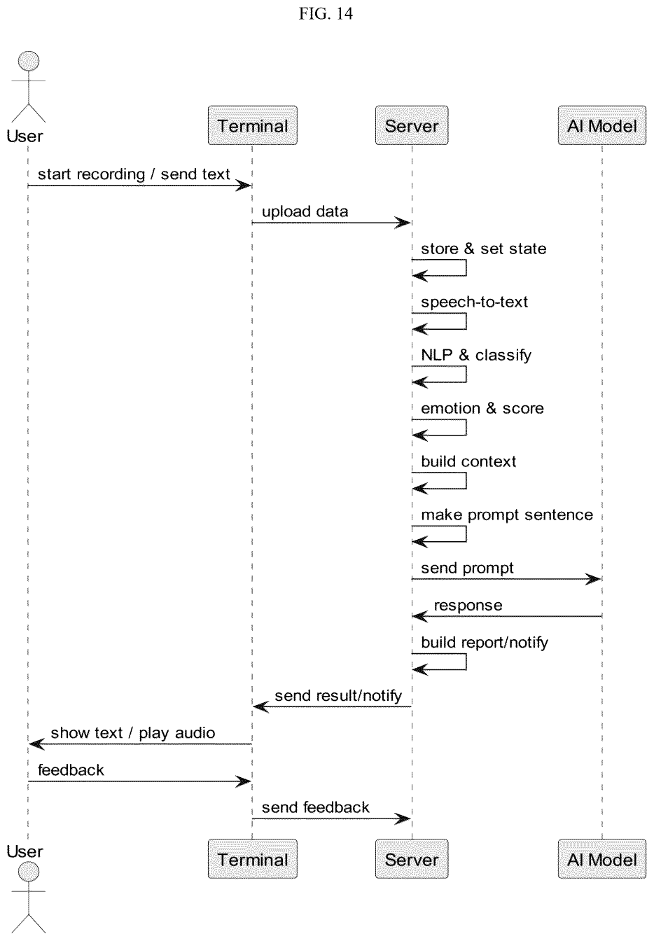

The following describes the processing flow using FIG. 14.

### Step 1:

The terminal acquires source data and transmits it to the server.
The terminal records audio information using a microphone, acquires character information such as messages or documents from local storage or user input, and attaches metadata including a user identifier, time information, and context labels. The terminal packages these data elements into a transmission unit and sends the unit to the server via a network protocol.
Input: raw audio signals, text messages, and document files.
Output: one or more data packets containing encoded audio, text, and metadata transmitted to the server.

### Step 2:

The server receives the source data and registers processing states.
The server accepts incoming data packets through an application programming interface, verifies authentication tokens and data integrity, and decodes audio and text formats. The server writes audio files and documents to a storage resource and inserts a record for each item into a source data table, setting a processing state field to an initial value.
Input: data packets containing encoded audio, text, and metadata.
Output: stored audio and text objects and corresponding database records with initial processing states.

### Step 3:

The server converts audio information into character information.
The server reads audio objects whose processing state requires transcription, normalizes sampling rates, and segments long audio into manageable chunks. The server sends each chunk to a speech recognition engine or executes a local acoustic model to obtain a text transcript. The server concatenates chunk-level transcripts, aligns them with timestamps, and stores the resulting character information back into the database linked to the original audio record.
Input: audio objects and associated metadata.
Output: character information (transcripts) with alignment data stored in association with the audio records.

### Step 4:

The server performs basic natural language processing on the character information.
The server retrieves character information whose processing state indicates that transcription is completed. The server applies a tokenizer to split the text into sentences and tokens, then performs part-of-speech tagging and syntactic dependency parsing using a language model.
The server extracts named entities and key phrases and builds structured representations such as token arrays and dependency graphs.
Input: character information for one or more documents or transcripts.
Output: structured linguistic annotations including token lists, part-of-speech tags, dependency relations, and extracted entities stored as structured data.

### Step 5:

The server identifies business-related, resolution-related, and problem-related content.
The server analyzes the structured linguistic annotations using rule sets and classifiers to detect segments that describe business activities, solutions, or problems. The server scans for patterns such as verbs indicating actions, nouns indicating processes or resources, and lexical markers of issues or resolutions. The server groups related sentences into segments and labels each segment with a category indicating business-related content, resolution-related content, or problem-related content.
Input: structured linguistic annotations for sentences and paragraphs.
Output: labeled segments where each segment contains text and a category label indicating its business relevance.

### Step 6:

The server computes emotion and polarity for each segment.
The server passes each labeled segment's text to an emotion analysis module, either via an external service or a local classifier. The server converts the text into a feature representation, such as token embeddings, and computes probabilities for positive, negative, neutral, and optional fine-grained emotion classes. The server assigns an emotional state label and stores both the label and the probability distribution with the segment record.
Input: segment texts and category labels.
Output: emotion labels and probability scores attached to each segment record.

### Step 7:

The server calculates an importance degree for each piece of content.
The server constructs feature vectors for segments by combining emotion scores, category labels, keyword presence, frequency counts, and contextual indicators such as mentions of deadlines or customers. The server applies a scoring function, for example a weighted sum or a learned regression model, to compute an importance degree. The server normalizes the scores and stores a numeric value representing the relative priority of each segment.
Input: segment metadata including emotion scores, category labels, and contextual features.
Output: an importance degree value associated with each segment.

### Step 8:

The server selects segments for inclusion in contextual information.
The server filters segments based on their importance degrees and emotional states, discarding or aggregating low-importance neutral segments and selecting higher-importance segments for detailed processing. The server orders the selected segments by importance or time and groups them according to the task type, such as summarization or solution proposal.
The server then assembles a contextual information structure containing the selected texts, category labels, emotion labels, and importance degrees.
Input: segments with category labels, emotion labels, and importance degrees.
Output: contextual information structures grouping selected segments with associated metadata.

### Step 9:

The server chooses a template according to a task type.
The server determines a task type for each contextual information structure, for example summary generation, topic extraction, solution proposal, or response-guideline generation.
The server maps the task type to a corresponding template that contains fixed instruction text and placeholder markers for lists of issues, solutions, or topics. The server loads the selected template into memory in preparation for prompt construction.
Input: contextual information structures and their designated task types.
Output: selected templates corresponding to each task type ready for population.

### Step 10:

The server generates a prompt sentence by embedding contextual information into the template.
The server gathers text fragments from the contextual information, such as bullet lists of problem-related content, summaries of resolution-related content, or key phrases for topics.
The server replaces placeholders in the template with these constructed fragments, preserving required formatting such as numbered lists or quoted segments. The server thereby produces a complete prompt sentence or prompt text block that encodes both the instruction and the relevant context for the generative AI model.
Input: contextual information structures and selected templates.
Output: completed prompt sentences containing instruction text and embedded contextual content.

### Step 11:

The server transmits the prompt sentence to a generative AI model and obtains a response.
The server sends each completed prompt sentence to a generative AI model through an application programming interface, specifying parameters such as maximum output length and sampling temperature. The server receives a generated sequence of tokens that form the response content, and may perform basic validation such as checking for minimum length or required list markers. The server associates the response content with the originating contextual information and stores it in a response table.
Input: prompt sentences for one or more tasks.
Output: response content texts generated by the generative AI model and linked to their corresponding prompts and contexts.

### Step 12:

The server structures the response content into report, list, notification, or guidance information.
The server parses each response content to detect headings, item delimiters, and paragraph boundaries. The server separates the response into logical units, such as summary sections, bullet items, or dialogue scripts, and assigns type labels to each unit. The server then constructs higher-level objects representing report information, list information, notification information, or guidance information, and records relations between these objects and the segments they address.
Input: response content texts generated by the generative AI model.
Output: structured response objects categorized as report information, list information, notification information, or guidance information.

### Step 13:

The server generates notification information for high-priority content.
The server scans the structured response objects and the underlying segments for those whose importance degrees exceed a threshold and whose emotion labels indicate negative or dissatisfaction-related states. For these high-priority entries, the server composes concise notification payloads containing a title, a short description, and references to the full response content. The server marks these payloads as notification information intended for immediate delivery to terminals.
Input: structured response objects and associated segment importance and emotion metadata.
Output: notification payloads identifying high-priority content and linking to detailed response objects.

### Step 14:

The server converts structured response objects into display information and voice output information.
The server formats report and list objects into display-ready representations, such as markup or user interface layouts, inserting headings, bullet points, and links. The server converts guidance scripts into text optimized for voice output, optionally embedding prosodic hints for text-to-speech engines. The server bundles the formatted data into response messages that distinguish between visual content and audio-oriented content.
Input: structured response objects and notification payloads.
Output: display information and voice output information packaged for transmission to terminals.

### Step 15:

The server delivers output information and notification information to terminals.
The server sends notification payloads to registered terminals using push notification mechanisms or server-initiated messages. The server exposes endpoints through which terminals can request the associated display information or voice output information when a user selects a notification. The server updates processing states in the database to record that delivery has been attempted or completed.
Input: display information, voice output information, and notification payloads.
Output: transmitted notifications and output information delivered to terminals, along with updated delivery status records.

### Step 16:

The terminal presents the received output information to the user.
The terminal receives notification payloads and renders them in a user interface element such as a banner, alert, or list entry. After the user selects a notification, the terminal requests the corresponding display information or voice output information from the server, receives the response, and presents it within an application view. The terminal may show text and lists on a screen or pass voice output information to a text-to-speech engine to play synthesized speech through speakers or headphones.
Input: notification payloads, display information, and voice output information from the server.
Output: visual or audio presentation of summaries, lists, or guidance to the user.

### Step 17:

The user interacts with the presented information and optionally provides feedback.
The user reads or listens to the summaries, issues, and proposed solutions shown by the terminal and may choose to follow suggested actions, dismiss notifications, or mark certain outputs as useful or incorrect. The user's selections and feedback are captured by the terminal and transmitted back to the server as interaction logs or feedback records.
Input: displayed or spoken information provided by the terminal and user actions such as selections, confirmations, or feedback entries.
Output: user interaction data and feedback records sent to the server for storage and possible use in subsequent optimization of processing parameters.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

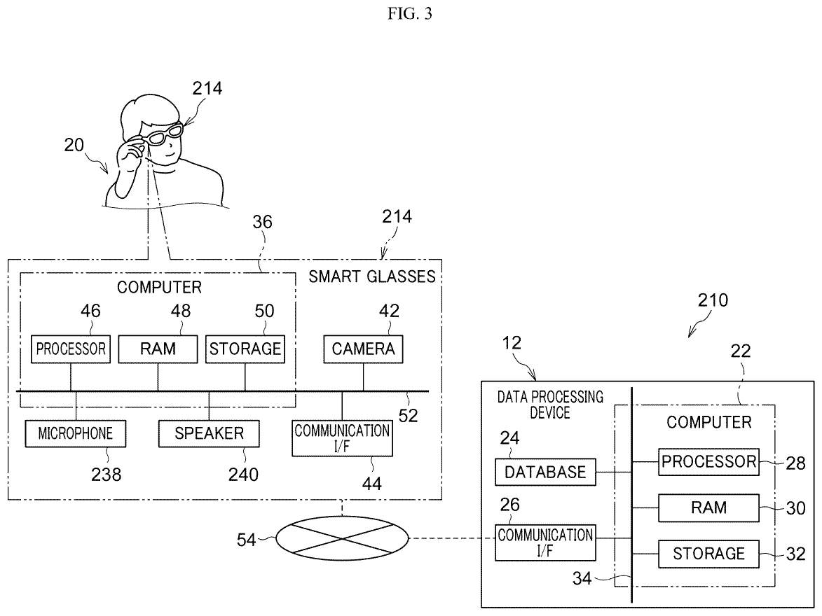

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

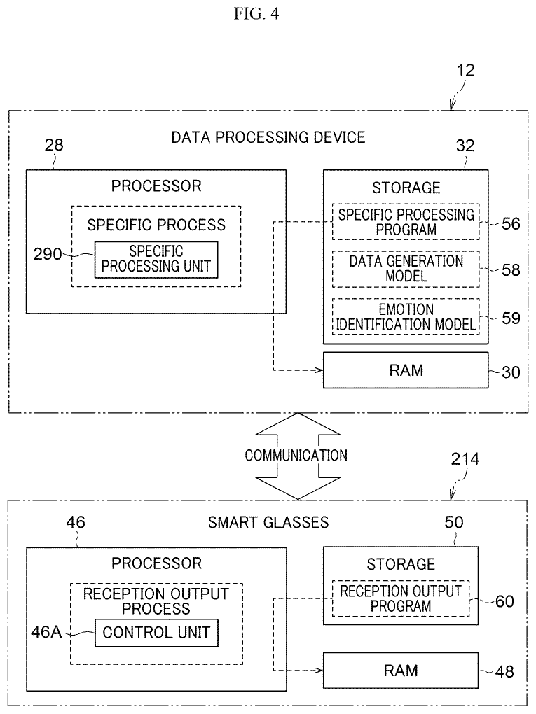

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

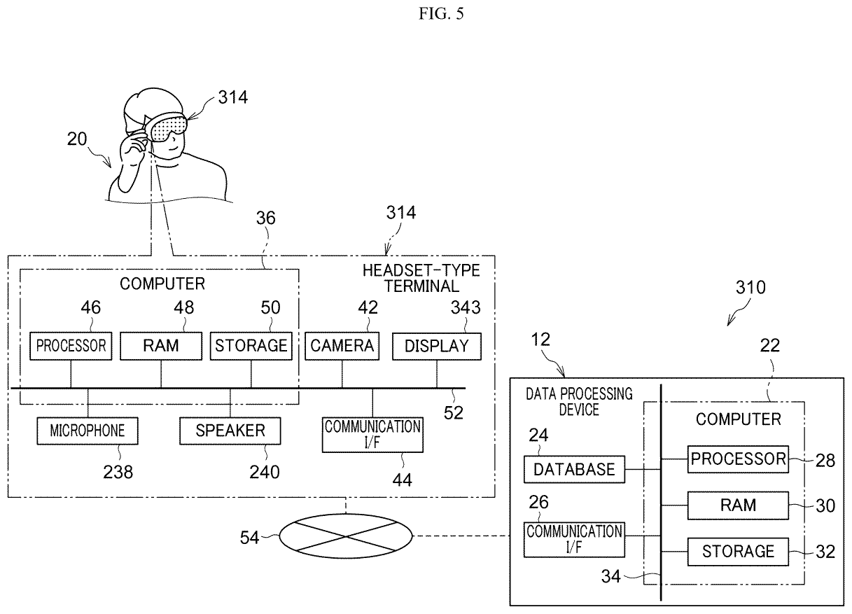

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

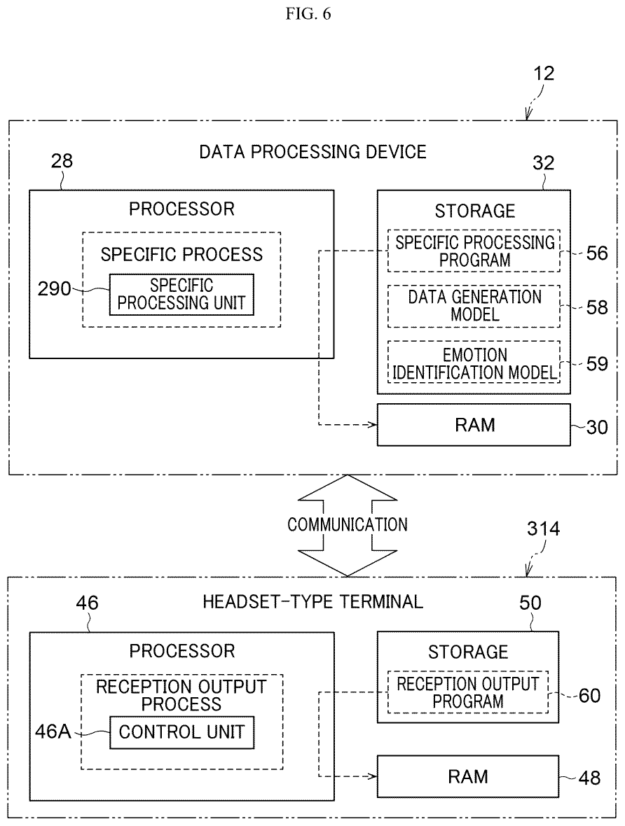

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

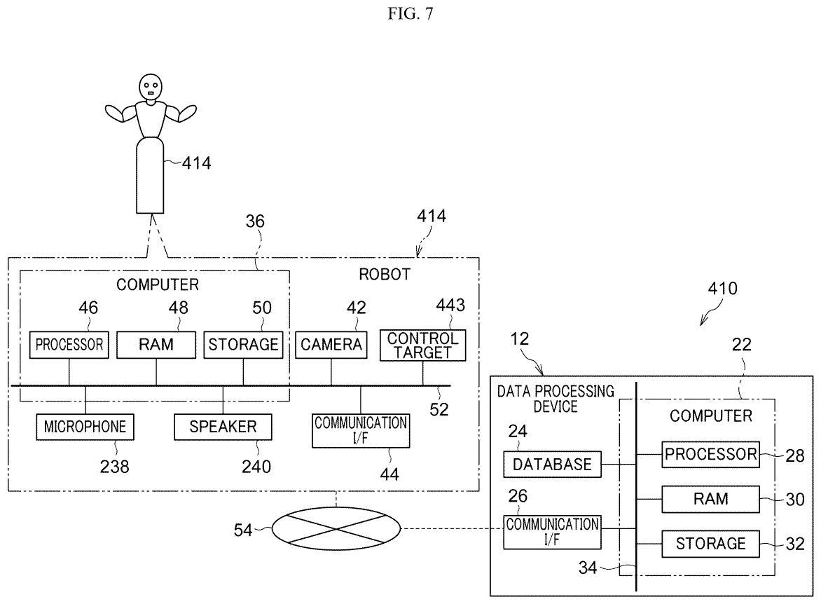

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

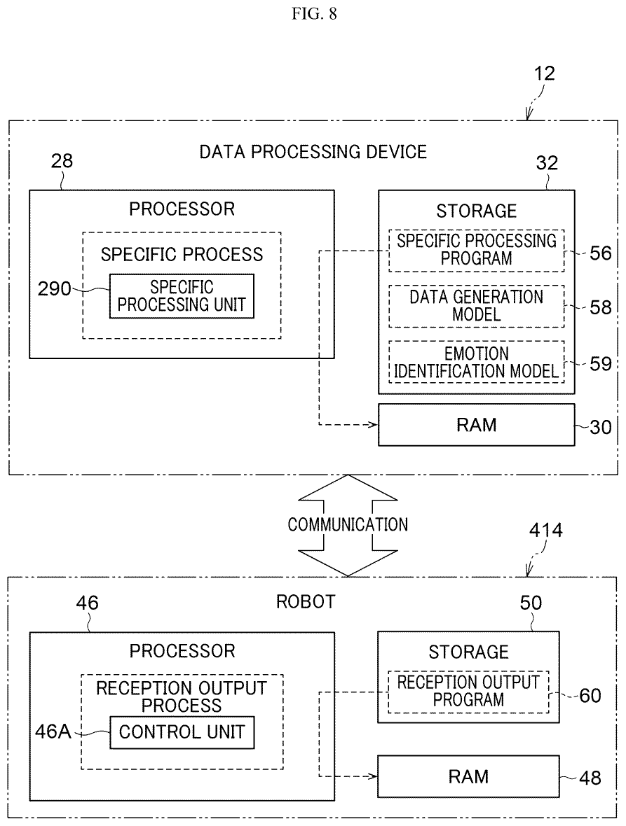

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

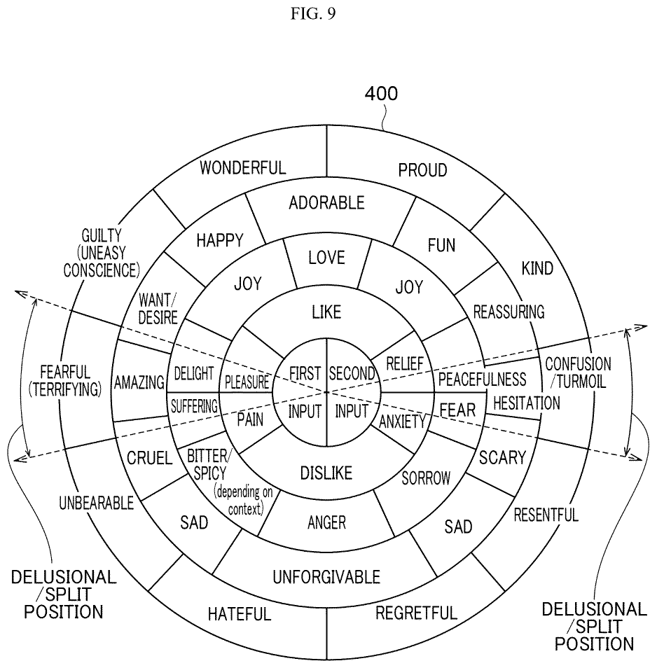

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

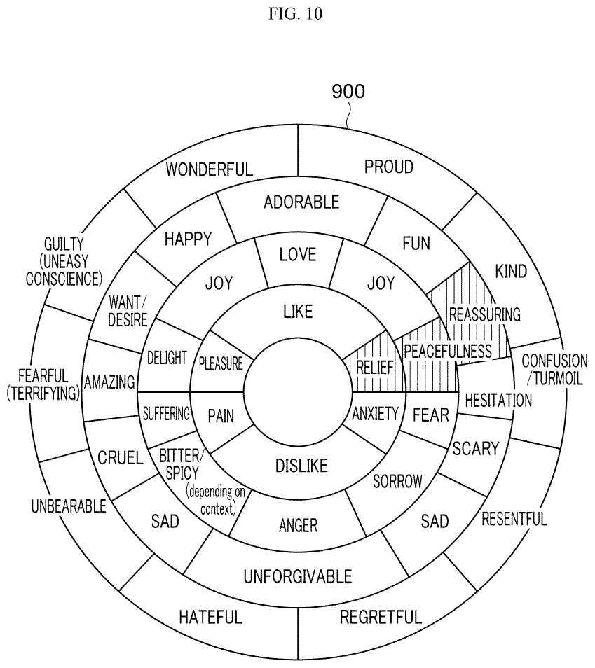

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire source information including meeting audio information, text information obtained via a communication means, and non-confidential reference information, and store the acquired source information,
convert the meeting audio information into character information by using a speech recognition technique, extract text information from the text information obtained via the communication means and from the non-confidential reference information, and perform preprocessing on the character information and the text information by using a natural language processing technique, the preprocessing including sentence segmentation, word segmentation, part-of-speech tagging, and syntactic analysis, to extract descriptions indicating business content, issues, and candidate solutions, and store an extraction result as structured data,
classify the business content, the issues, and the candidate solutions on the basis of the structured data, aggregate the business content, the issues, and the candidate solutions according to frequency information, time-series information, and affiliation information, and
generate summary information for each organization unit or each period, automatically generate a prompt sentence that instructs a generative artificial intelligence model to generate a natural-language response relating to the business content, the issues, and the candidate solutions, on the basis of the summary information and the structured data, and construct the prompt sentence so as to include query conditions and an output format,
input the prompt sentence to the generative artificial intelligence model, receive a response result returned from the generative artificial intelligence model, and store the response result in association with the structured data,
calculate indicators indicating occurrence tendencies of the issues, proposal states of the candidate solutions, and business states for each organization on the basis of the structured data and the response result, and convert the indicators into visualization data,
display the indicators and the response result as graphs, tables, and summary sentences on a dashboard screen on a display apparatus by using the visualization data, and update display contents in response to an operation by a user,
acquire a natural-language prompt sentence received from the user via an input terminal,
analyze the prompt sentence to extract search conditions indicating an organization unit, a period, target business content, and an output format, search the structured data and the response result on the basis of the search conditions, and generate an additional prompt sentence to which a context for input to the generative artificial intelligence model is added on the basis of a search result, and
input the additional prompt sentence to the generative artificial intelligence model and provide an obtained response to the user via at least one of the display apparatus and an audio output apparatus.

### Supplementary 2

The system according to supplementary 1,
wherein the processor is configured to register the structured data in a full-text search index,
search the full-text search index on the basis of the search conditions extracted from the natural-language prompt sentence from the user, and add a search result as context to the prompt sentence to be input to the generative artificial intelligence model.

### Supplementary 3

The system according to supplementary 1,
wherein the processor is configured to associate the response result obtained from the generative artificial intelligence model with the visualization data indicating the indicators,
append transition information to a visualization screen corresponding to an element in the response result, and display a corresponding dashboard screen in response to a selection operation by the user on the response result.

### Application Example 1

### Supplementary 1

A system comprising a processor,
wherein the processor is configured to
receive, as original data, sound information in a meeting, character information transmitted and received by a communication means, and low-confidentiality document information, normalize the original data into text information, and store the text information,
perform natural language processing including morphological analysis, syntactic analysis, and named entity extraction on the text information to extract business activities, business issues, business constraints, and business objectives, and organize an extraction result as structured data on a unit basis of a process or a facility,
generate, on the basis of the structured data, a prompt sentence for causing a generative AI model to linguistically express solutions and issues for improving work efficiency in a production site, the prompt sentence including instructions relating to an objective, constraint conditions, and an output format,
input the prompt sentence into the generative AI model and acquire solution information and issue information generated on the basis of the structured data and the prompt sentence,
convert the solution information and the issue information into display data, transmit the display data to a display terminal via a network, and present the display data, and
acquire adoption information and comment information of a user with respect to the solution information and the issue information from the display terminal, and update generation conditions of the prompt sentence or an organization method of the structured data on the basis of the adoption information and the comment information.

### Supplementary 2

The system according to supplementary 1,
wherein the processor is configured to
perform, as the normalization of the text information, a process of converting the sound information into the character information by voice recognition processing and integrating the character information, the character information of the communication means, and the document information into a common-format data structure.

### Supplementary 3

The system according to supplementary 1,
wherein the processor is configured to
perform, as the organization of the structured data, a process of calculating a priority on the basis of occurrence frequencies and impact degrees of a plurality of the business issues, and selecting the business issues and solution candidates to be included in the prompt sentence according to the priority.

### Example 2

### Supplementary 1

A system comprising a processor,
wherein the processor is configured to
receive source data including audio data, text data, and non-confidential document data input to an information processing apparatus,
convert the audio data included in the source data into text data by using a speech recognition technique,
analyze the source data and the text data by using a natural language processing technique to perform sentence segmentation, word segmentation, part-of-speech tagging, syntactic parsing, phrase extraction, and classification processing, and thereby extract business information, issue information, and solution information related to an organization,
generate a prompt sentence requesting a generative information processing model to summarize or supplement the business information, the issue information, and the solution information, based on the extracted business information, issue information, and solution information,
input the generated prompt sentence and the extracted information to the generative information processing model and acquire response information from the generative information processing model, and
generate business report document data by using the extracted information and the response information, store the business report document data in a storage area, and make the business report document data referable from a terminal device.

### Supplementary 2

The system according to supplementary 1,
wherein the processor is configured to
utilize, as the speech recognition technique, a speech recognition process executed via an external information processing service,
utilize, as the natural language processing technique, a program library that performs morphological analysis, syntactic analysis, and semantic analysis,
utilize, as the generative information processing model, a generative information processing engine provided via an external information processing service, and
generate the prompt sentence including wording that instructs extraction and summarization of important business contents, issues, and solutions from meeting records.

### Supplementary 3

The system according to supplementary 1,
wherein the processor is configured to
structure the business report document data as items separated for the extracted business information, the issue information, and the solution information, and provide the business report document data to a user via a display device or an audio output device.

### Application Example 2

### Supplementary 1

A system comprising a processor,
wherein the processor is configured to
receive source data including audio information related to meetings, character information related to communications, and sharable record information, store the source data in a storage resource together with management information indicating a processing state for each item of the source data, and manage the processing state of the source data,
convert audio information included in the source data into character information by using a speech recognition technique, perform natural language processing on the character information including segmentation, part-of-speech tagging, syntactic analysis, and phrase extraction, and extract, based on a result of the natural language processing, business-related content, resolution-related content, and problem-related content,
evaluate the extracted character information by using an emotion analysis technique, determine polarity and an emotional state of utterance content, reclassify, based on a determination result, the business-related content as the resolution-related content or the problem-related content, and calculate an importance degree of each piece of content,
organize contextual information including the extracted and reclassified business-related content, the resolution-related content, the problem-related content, and the importance degree, and generate a prompt sentence for a generative artificial intelligence model by embedding the contextual information into a predetermined instruction format so as to cause the generative artificial intelligence model to perform at least one of verbalization, summarization, proposal generation, or explanation generation regarding the resolution-related content or the problem-related content,
structure a response content obtained from the generative artificial intelligence model based on the generated prompt sentence and the contextual information as at least one of report information, list information, notification information, or guidance information, and convert the response content into an output format as display information or voice output information, and
provide the information converted into the output format to a user device having a display function or a voice output function, and present the information to a user via the user device.

### Supplementary 2

The system according to supplementary 1,
wherein the processor is configured to
generate the prompt sentence to be transmitted to the generative artificial intelligence model based on a plurality of templates corresponding to task types including a summary generation task, a topic extraction task, a solution proposal task, and a response-guideline generation task, and create the prompt sentence by inserting, into the templates, the business-related content, the resolution-related content, the problem-related content, and information indicating the emotional state.

### Supplementary 3

The system according to supplementary 1,
wherein the processor is configured to
select, based on the importance degree and the emotional state, problem-related content or dissatisfaction-related content concerning a customer as high-priority content, generate notification information for performing immediate notification to the user device regarding information in the output format corresponding to the high-priority content, and transmit the notification information to the user device.

What is claimed is:

1. A system comprising:
circuitry configured to:
receive, via a communication interface coupled to a packet-switched network, heterogeneous source data from a terminal device, the heterogeneous source data comprising audio data representing spoken content, text-based communication data, and reference document data, and store the heterogeneous source data in a storage device;
convert the audio data into character data by executing a speech recognition process, extract text segments from the text-based communication data and the reference document data, and perform natural language processing on the character data and the text segments, the natural language processing comprising sentence segmentation, word segmentation, part-of-speech tagging, and syntactic analysis, so as to extract structured records representing activity descriptors, issue descriptors, and solution candidate descriptors, and store the structured records in a data store;
classify the activity descriptors, the issue descriptors, and the solution candidate descriptors based on the structured records, aggregate the classified descriptors according to frequency information, time-series information, and affiliation information, and generate summary data representing aggregated content for each organizational unit or each time period;
automatically construct a prompt sentence that includes query conditions and a designated output format based on the summary data and the structured records, and transmit the prompt sentence to a generative model via the communication interface;
receive a generation result returned from the generative model, store the generation result in association with the structured records, compute indicator values representing occurrence tendencies of the issue descriptors, proposal states of the solution candidate descriptors, and activity states per organizational unit based on the structured records and the generation result, and convert the indicator values into visualization data; and
receive a natural-language query from the terminal device via the communication interface, extract search conditions from the natural-language query, retrieve matching records from the structured records and the generation result based on the search conditions, construct an additional prompt sentence incorporating the retrieved records as context, transmit the additional prompt sentence to the generative model, and transmit a response obtained from the generative model to the terminal device.

2. The system according to claim 1, wherein the natural language processing further comprises named entity extraction, and wherein the circuitry is configured to associate the extracted named entities with the activity descriptors, the issue descriptors, and the solution candidate descriptors in the structured records.

3. The system according to claim 2, wherein the circuitry is configured to index the structured records using a full-text index, and wherein extracting the search conditions from the natural-language query comprises parsing the natural-language query to identify at least one of an organizational unit identifier, a time period, target activity content, and a response output format.

4. The system according to claim 3, wherein the circuitry is configured to rank the retrieved matching records by relevance score computed based on term frequency and index position, and construct the additional prompt sentence by inserting the highest-ranked matching records as a context block preceding the query conditions.

5. The system according to claim 4, wherein the circuitry is configured to receive corrective input from the terminal device in response to the response obtained from the generative model, generate a correction prompt sentence incorporating the corrective input and the previously retrieved matching records, transmit the correction prompt sentence to the generative model, and update the stored generation result with a corrected generation result.

6. The system according to claim 1, wherein the circuitry is configured to convert the indicator values into at least one of graph data, table data, and summary sentence data, and transmit the converted data to a display apparatus so as to render a dashboard screen, and to update the dashboard screen in response to a user operation received from the terminal device.

7. The system according to claim 6, wherein the circuitry is configured to identify, in response to a user selection of a summary sentence displayed on the dashboard screen, the structured records and the indicator values linked to the selected summary sentence, and update the dashboard screen to display the linked structured records and indicator values.

8. The system according to claim 1, wherein the circuitry is configured to normalize the audio data, the text-based communication data, and the reference document data into a unified text format prior to performing the natural language processing, and store the unified text format together with management information indicating a processing state for each item of the source data.

9. The system according to claim 8, wherein the management information indicates at least one of a reception state, a preprocessing state, a structured data generation state, a generation result association state, and a dashboard update state for each item of the source data, and wherein the circuitry is configured to update the management information upon completion of each processing stage.

10. The system according to claim 1, wherein the circuitry is configured to compute, for each organizational unit, a trend coefficient based on the time-series information of the issue descriptors, and to generate a predictive indicator value representing an estimated future occurrence tendency of the issue descriptors based on the trend coefficient.

11. The system according to claim 10, wherein the circuitry is configured to compare the predictive indicator value against a predetermined threshold, and to generate an alert notification directed to the terminal device when the predictive indicator value exceeds the threshold.

12. The system according to claim 1, wherein the circuitry is configured to detect an emotion state of a user based on audio data received from the terminal device using an emotion identification model, and to adjust a response format or a level of detail of the response transmitted to the terminal device based on the detected emotion state.

13. The system according to claim 12, wherein the emotion identification model is a machine learning model trained to output an emotion category label and a confidence score from input audio features, and wherein adjusting the response format comprises selecting among a concise-mode format and a detailed-mode format based on the emotion category label.

14. The system according to claim 1, wherein the circuitry is configured to receive, as the text-based communication data, message data from at least one of an electronic mail system, a messaging platform, and a collaboration tool, and to tag each text segment with a source channel identifier prior to performing the natural language processing.

15. The system according to claim 14, wherein the circuitry is configured to weight the activity descriptors, the issue descriptors, and the solution candidate descriptors during the aggregation step based on the source channel identifier, such that descriptors originating from a first channel type are assigned a higher aggregation weight than descriptors originating from a second channel type.

16. The system according to claim 1, wherein the circuitry is configured to store the prompt sentence and the additional prompt sentence in a prompt history data store in association with the structured records used to construct each respective prompt sentence, and to retrieve a previously stored prompt sentence from the prompt history data store as a basis for constructing a subsequent prompt sentence when a new query matches previously stored search conditions.

17. The system according to claim 16, wherein the circuitry is configured to evaluate a similarity between the new query and the previously stored search conditions by computing a vector distance between respective embedding representations, and to reuse the previously stored prompt sentence when the vector distance falls below a similarity threshold.

18. A system comprising:
circuitry configured to:
receive, via a communication interface coupled to a packet-switched network, audio data representing spoken organizational content, communication message data, and reference document data from a terminal device, and store the received data in a storage device;
convert the audio data into character data by executing a speech recognition process, perform natural language processing on the character data and on text extracted from the communication message data and the reference document data to extract structured records comprising activity descriptors, issue descriptors, and solution candidate descriptors, and store the structured records in a data store;
aggregate the structured records according to frequency information, time-series information, and affiliation information to generate summary data per organizational unit;
construct a prompt sentence comprising the summary data and a designated output format, transmit the prompt sentence to a generative model via the communication interface, receive a generation result from the generative model, and store the generation result in association with the structured records; and
compute indicator values based on the structured records and the generation result, convert the indicator values into visualization data, and transmit the visualization data to the terminal device via the communication interface.

19. The system according to claim 18, wherein the circuitry is configured to receive a natural-language query from the terminal device, extract search conditions from the natural-language query, retrieve matching records from the data store based on the search conditions, construct an additional prompt sentence incorporating the retrieved matching records as context, and transmit a response obtained from the generative model using the additional prompt sentence to the terminal device.

20. A method comprising:
receiving, via a communication interface coupled to a packet-switched network, heterogeneous source data from a terminal device, the heterogeneous source data comprising audio data representing spoken content, text-based communication data, and reference document data, and storing the heterogeneous source data in a storage device;
converting the audio data into character data by executing a speech recognition process, extracting text segments from the text-based communication data and the reference document data, and performing natural language processing on the character data and the text segments, the natural language processing comprising sentence segmentation, word segmentation, part-of-speech tagging, and syntactic analysis, so as to extract structured records representing activity descriptors, issue descriptors, and solution candidate descriptors, and storing the structured records in a data store;
classifying the activity descriptors, the issue descriptors, and the solution candidate descriptors based on the structured records, aggregating the classified descriptors according to frequency information, time-series information, and affiliation information, and generating summary data representing aggregated content for each organizational unit or each time period;
automatically constructing a prompt sentence that includes query conditions and a designated output format based on the summary data and the structured records, and transmitting the prompt sentence to a generative model via the communication interface;
receiving a generation result returned from the generative model, storing the generation result in association with the structured records, computing indicator values representing occurrence tendencies of the issue descriptors, proposal states of the solution candidate descriptors, and activity states per organizational unit based on the structured records and the generation result, and converting the indicator values into visualization data; and
receiving a natural-language query from the terminal device via the communication interface, extracting search conditions from the natural-language query, retrieving matching records from the structured records and the generation result based on the search conditions, constructing an additional prompt sentence incorporating the retrieved records as context, transmitting the additional prompt sentence to the generative model, and transmitting a response obtained from the generative model to the terminal device.
